(19) United States
(12) Patent Application Publication
(10) Pub. No.: US 2025/0085435 A1
(43) Pub. Date: Mar. 13, 2025

(54) ANTI-SPOOFING CONSIDERATIONS IN MAP-AIDING POSITIONING

(71) Applicant: QUALCOMM Incorporated, San Diego, CA (US)

(72) Inventors: Yuxiang PENG, Sunnyvale, CA (US); Bala RAMASAMY, San Marcos, CA (US); Danlu ZHANG, San Diego, CA (US); Ning LUO, Cupertino, CA (US)

(21) Appl. No.: 18/465,903

(22) Filed: Sep. 12, 2023

(51) Int. Cl. G01S 19/20; G01C 21/00

(52) U.S. Cl. CPC G01S 19/20; G01C 21/3804

(57) ABSTRACT

Aspects presented herein may enable a UE to verify the integrity of map data, thereby improving the accuracy and safety of map-aiding positioning and/or map-based positioning. In one aspect, a UE performs a map-aiding positioning based on a first set of map data. The UE verifies whether an integrity of the first set of map data meets an accuracy threshold. The UE discards the first set of map data if the verification of the integrity of the first set of map data does not meet the accuracy threshold. For example, the UE may compare the first set of map data with a second set of map data from a different source, and identify the integrity of the first set of map data does not meet the accuracy threshold if the comparison shows an indication of inconsistency above a consistency threshold.

### TECHNICAL FIELD

The present disclosure relates generally to communication systems, and more particularly, to a wireless communication involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

In some scenarios, a spoofer may seed a manipulated map data to a navigation application, causing the navigation application to provide inaccurate (and dangerous) navigation guidance. As such, aspects presented herein may improve the accuracy and safety of map-aiding positioning or map-based positioning by enabling a positioning device to verify the integrity of map data, and to avoid map data spoofing events for map-aiding location technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus performs a map-aiding positioning based on a first set of map data. The apparatus verifies whether an integrity of the first set of map data meets an accuracy threshold. The apparatus discards the first set of map data if the verification of the integrity of the first set of map data does not meet the accuracy threshold.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of camera-aided positioning in accordance with various aspects of the present disclosure.

FIG. 6 is a diagram illustrating an example of a navigation application in accordance with various aspects of the present disclosure.

FIG. 7 is a diagram illustrating an example of manipulated (spoofed) map data in accordance with various aspects of the present disclosure.

FIG. 8 is a diagram illustrating an example of validating (the authenticity/integrity of) source map data based on a multiple map source crosscheck in accordance with various aspects of the present disclosure.

FIG. 9 is a diagram illustrating an example of validating (the authenticity/integrity of) source map data based on a visual data consistency check using at least one camera in accordance with various aspects of the present disclosure.

FIG. 10 is a diagram illustrating an example of validating (the authenticity/integrity of) source map data based on a global navigation satellite system (GNSS)/inertial measurement unit (IMU)/magnetometer sensor consistency check in accordance with various aspects of the present disclosure.

FIG. 11 is a diagram illustrating an example of a data buffer mechanism in accordance with various aspects of the present disclosure.

FIG. 12 is a diagram illustrating an example of a UE establishing map data using at least one sensor in accordance with various aspects of the present disclosure.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

### DETAILED DESCRIPTION

Aspects presented herein may improve the accuracy and safety of map-aiding positioning or map-based positioning by enabling a positioning device (e.g., a user equipment (UE)) to verify the integrity of map data, and to avoid map data spoofing events for map-aiding location technologies. In one aspect, a positioning device may be configured to validate a source map and/or a street image to avoid intentional spoofing based on using at least one of: a multi-map source crosscheck, a visual data consistency check (e.g., using at least one camera), a global navigation satellite system (GNSS), inertial measurement unit (IMU), and/or magnetometer sensor consistency check, a radio frequency (RF)-beacon check, and/or a radar-based consistency check, etc. In another aspect, a positioning device may be configured to validate a source map and/or a street image based on a data buffer mechanism, which may also minimize visual location data queries (if used opportunistically) and avoid real-time communication latency. In another aspect, a positioning device may be configured to validate a source map and/or a street image by establish map data using sensor(s) of the positioning device, such as obtaining basic knowledge of visited environment(s) and leverage historical data in the past for future usage. In another aspect, a positioning device may be configured to validate a source map and/or a street image using an asset-tracking-based approach.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

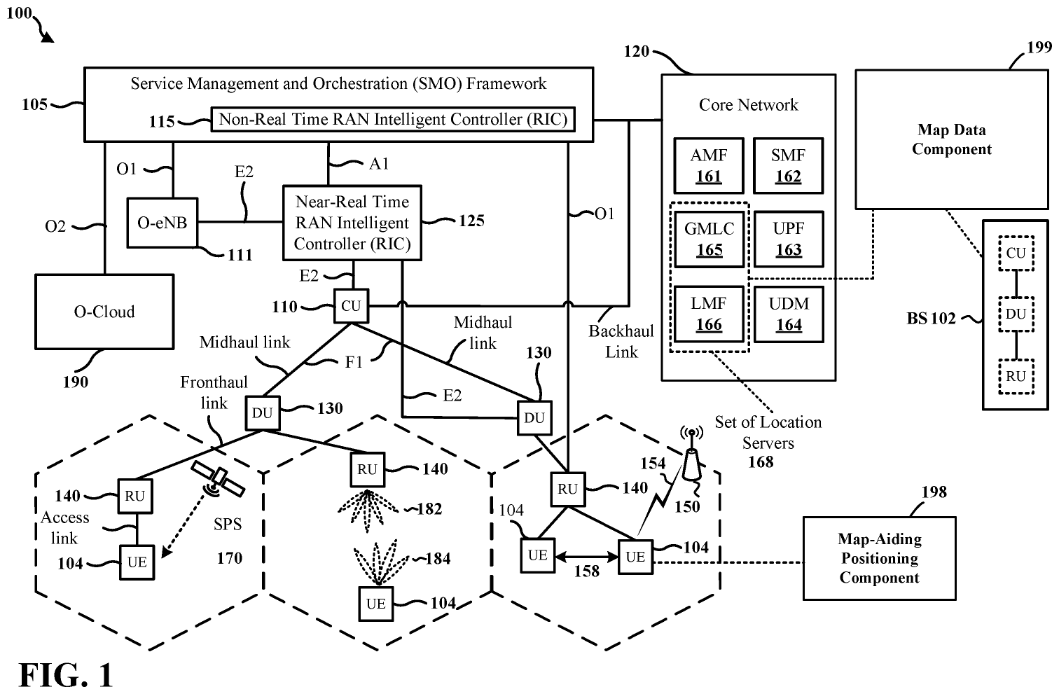

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a map-aiding positioning component 198 that may be configured to perform map-aiding positioning based on a first set of map data; verify whether an integrity of the first set of map data meets an accuracy threshold; and discard the first set of map data if the verification of the integrity of the first set of map data does not meet the accuracy threshold. In certain aspects, a server (e.g., the first server 804, the server 1104, the map server 1204), the base station 102 or the one or more location servers 168 may have a map data component 199 that may be configured to provide map data to the UE 104.

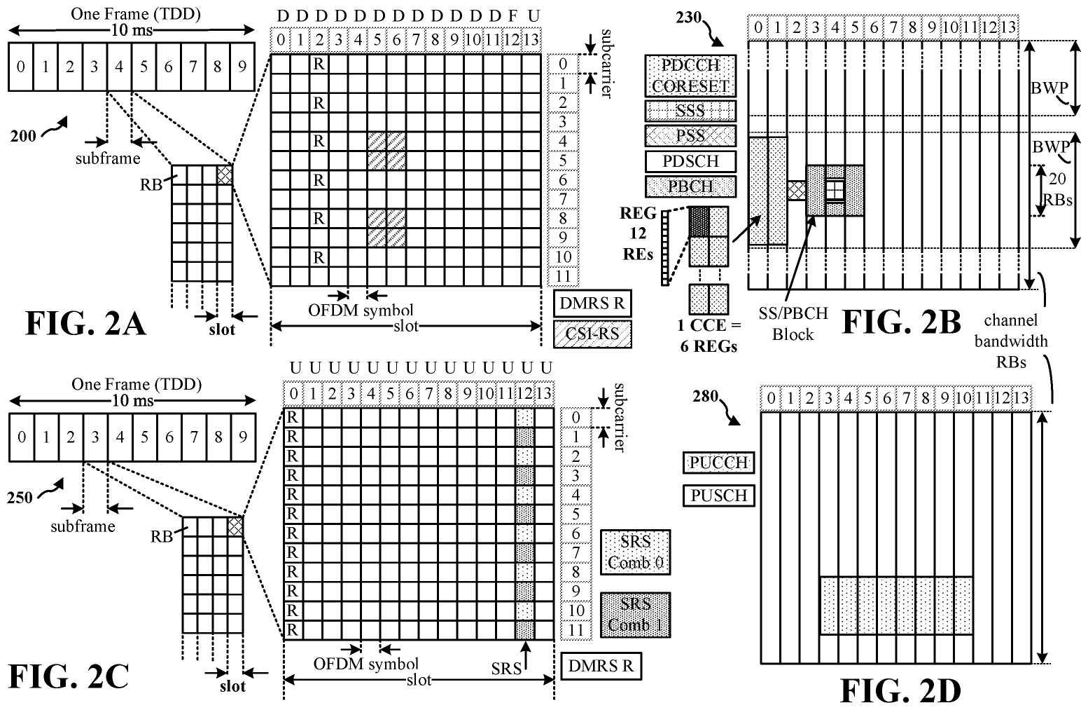

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

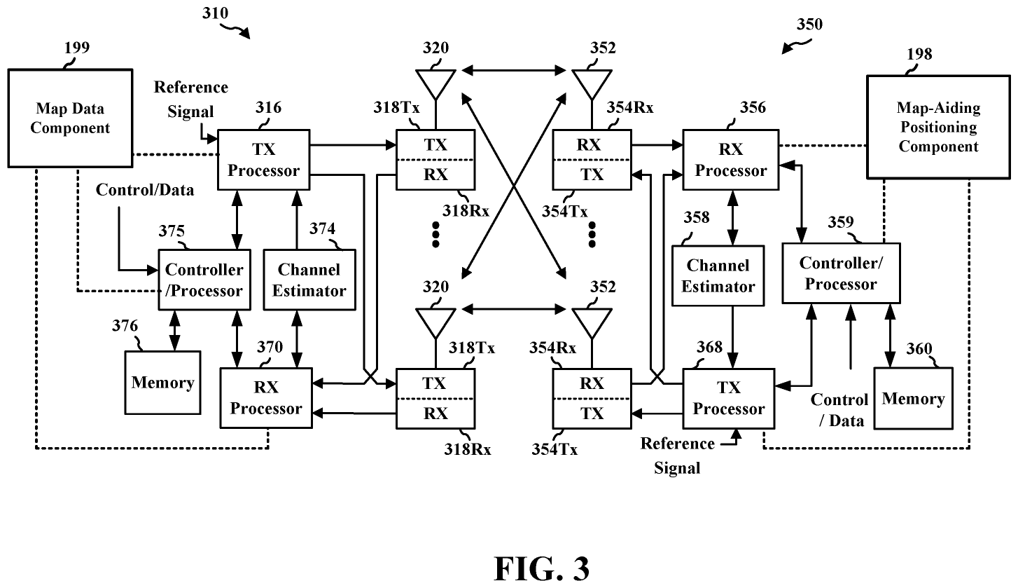

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the map-aiding positioning component 198 of FIG. 1.

At least one of the TX processor 316, the RX processor 370, and the controller/processor 375 may be configured to perform aspects in connection with the map data component 199 of FIG. 1.

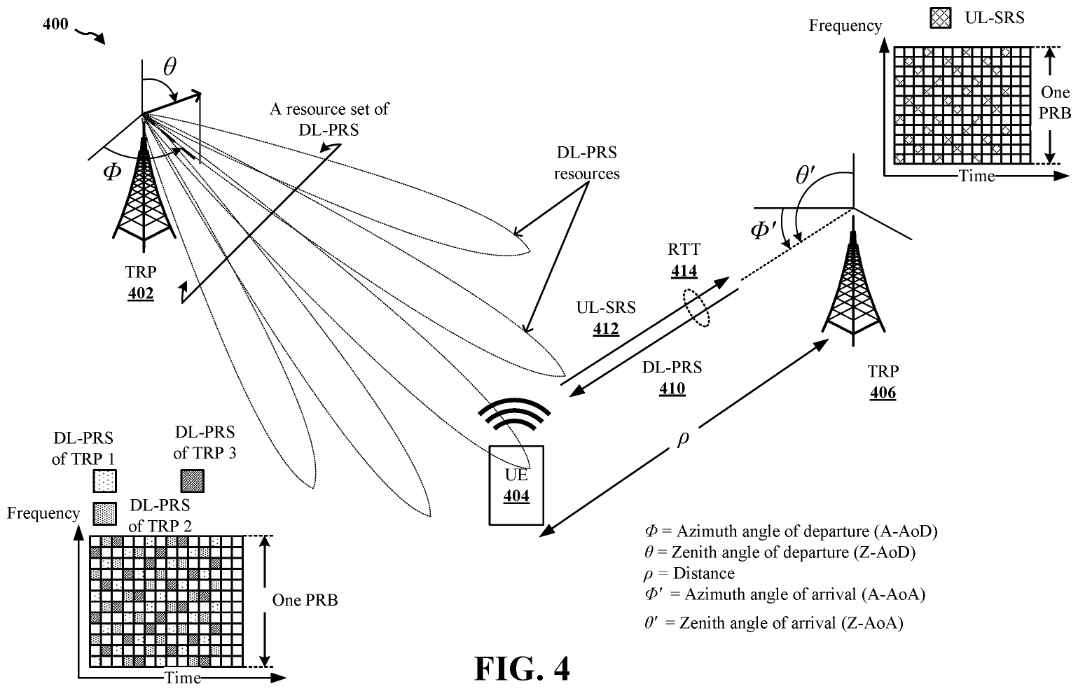

FIG. 4 is a diagram 400 illustrating an example of a UE positioning based on reference signal measurements (which may also be referred to as “network-based positioning”) in accordance with various aspects of the present disclosure. The UE 404 may transmit UL SRS 412 at time T_{SRS_TX} and receive DL positioning reference signals (PRS) (DL PRS) 410 at time T_{PRS_RX}. The TRP 406 may receive the UL SRS 412 at time T_{SRS_RX} and transmit the DL PRS 410 at time T_{PRS_TX}. The UE 404 may receive the DL PRS 410 before transmitting the UL SRS 412, or may transmit the UL SRS 412 before receiving the DL PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL PRS reference signal received power (RSRP) (DL PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL SRS-RSRP at multiple TRPs 402, 406 of uplink signals transmitted from UE 404. The UE 404 measures the UE Rx-Tx time difference measurements (and/or DL PRS-RSRP of the received signals) using assistance data received from the positioning server, and the TRPs 402, 406 measure the gNB Rx-Tx time difference measurements (and/or UL SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

PRSs may be defined for network-based positioning (e.g., NR positioning) to enable UEs to detect and measure more neighbor transmission and reception points (TRPs), where multiple configurations are supported to enable a variety of deployments (e.g., indoor, outdoor, sub-6, mmW, etc.). To support PRS beam operation, beam sweeping may also be configured for PRS. The UL positioning reference signal may be based on sounding reference signals (SRSs) with enhancements/adjustments for positioning purposes. In some examples, UL-PRS may be referred to as “SRS for positioning,” and a new Information Element (IE) may be configured for SRS for positioning in RRC signaling.

DL PRS-RSRP may be defined as the linear average over the power contributions (in [W]) of the resource elements of the antenna port(s) that carry DL PRS reference signals configured for RSRP measurements within the considered measurement frequency bandwidth. In some examples, for FR1, the reference point for the DL PRS-RSRP may be the antenna connector of the UE. For FR2, DL PRS-RSRP may be measured based on the combined signal from antenna elements corresponding to a given receiver branch. For FR1 and FR2, if receiver diversity is in use by the UE, the reported DL PRS-RSRP value may not be lower than the corresponding DL PRS-RSRP of any of the individual receiver branches. Similarly, UL SRS-RSRP may be defined as linear average of the power contributions (in [W]) of the resource elements carrying sounding reference signals (SRS). UL SRS-RSRP may be measured over the configured resource elements within the considered measurement frequency bandwidth in the configured measurement time occasions. In some examples, for FR1, the reference point for the UL SRS-RSRP may be the antenna connector of the base station (e.g., gNB). For FR2, UL SRS-RSRP may be measured based on the combined signal from antenna elements corresponding to a given receiver branch. For FR1 and FR2, if receiver diversity is in use by the base station, the reported UL SRS-RSRP value may not be lower than the corresponding UL SRS-RSRP of any of the individual receiver branches.

PRS-path RSRP (PRS-RSRPP) may be defined as the power of the linear average of the channel response at the i-th path delay of the resource elements that carry DL PRS signal configured for the measurement, where DL PRS-RSRPP for the 1st path delay is the power contribution corresponding to the first detected path in time. In some examples, PRS path Phase measurement may refer to the phase associated with an i-th path of the channel derived using a PRS resource.

DL-AoD positioning may make use of the measured DL PRS-RSRP of downlink signals received from multiple TRPs 402, 406 at the UE 404. The UE 404 measures the DL PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and/or DL PRS-RSRP) of downlink signals received from multiple TRPs 402, 406 at the UE 404. The UE 404 measures the DL RSTD (and/or DL PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and/or UL SRS-RSRP) at multiple TRPs 402, 406 of uplink signals transmitted from UE 404. The TRPs 402, 406 measure the UL-RTOA (and/or UL SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404. For purposes of the present disclosure, a positioning operation in which measurements are provided by a UE to a base station/positioning entity/server to be used in the computation of the UE's position may be described as “UE-assisted,” “UE-assisted positioning,” and/or “UE-assisted position calculation,” while a positioning operation in which a UE measures and computes its own position may be described as “UE-based,” “UE-based positioning,” and/or “UE-based position calculation.”

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. To further distinguish the type of PRS, a downlink positioning reference signal may be referred to as a “DL PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.” In addition, the term “location” and “position” may be used interchangeably throughout the specification, which may refer to a particular geographical or a relative place.

In addition to Global Navigation Satellite Systems (GNSS)-based positioning (e.g., positioning based on measuring signals from satellites) and network-based positioning (e.g., as described in connection with FIG. 4), various camera-based positioning has also been developed to provide alternative/additional positioning mechanisms/modes. Camera-based positioning, which may also be referred to as “camera-based visual positioning,” “visual positioning” and/or “vision-based positioning,” is a positioning mechanism/mode that uses images captured by at least one camera to determine the location of a target (e.g., a UE or a transportation that is equipped with the at least one camera, an object that is in the field-of-view (FOV) of the at least one camera, etc.). For example, images captured by the dashboard camera (dash cam) of a vehicle may be used for calculating the three-dimensional (3D) position and/or the 3D orientation of the vehicle while the vehicle is moving. Similarly, images captured by the camera of a mobile device may be used for estimating the location of the mobile device or the location of one or more objects in the images. In another example, a camera (or a UE) may determine its position by matching object(s) in images captured by the camera (or the UE) with object(s) in a map (e.g., a high-definition (HD) map), such as specified building(s), landmark(s), road/street sign(s), etc. In some implementations, camera-based positioning may provide centimeter-level and 6-degrees-of-freedom (6DOF) positioning. 6DOF may refer to a representation of how an object moves through a 3D space by either translating linearly or rotating axially (e.g., 6DOF=3D position+3D attitude). For example, a single-degree-of-freedom on an object may be controlled by the up/down, forward/back, left/right, pitch, roll, or yaw. Camera-based positioning may have great potential for various applications, such as in satellite signal (e.g., GNSS/GPS signal) degenerated/unavailable environments.

In some scenarios, images captured by a camera may also be used for improving the accuracy/reliability of other positioning mechanisms/modes (e.g., the GNSS-based positioning, the network-based positioning, etc.), which may be referred to as “vision-aided positioning,” “vision-aided precise positioning (VAPP),” “camera-aided positioning,” “camera-aided location,” and/or “camera-aided perception,” etc. For example, while positioning technology using GNSS and inertial measurement unit (IMU) coupling may enable highly accurate location solutions. When a GNSS measurement outage occurs (e.g., GNSS signals are unavailable or weak), however, the IMU bias drifting may degrade the accuracy of the positioning. Such IMU bias may also lead to initial sensor alignment and/or heading ambiguity with a static start. In other words, while GNSS and/or an IMU may provide good positioning/localization performance, when a GNSS measurement outage occurs, the overall positioning performance might degrade due to IMU bias drifting. Using camera vision opportunistically, challenged faced by the GNSS and IMU GNSS coupling solution may be mitigated with useful and reliable vision features. For example, images captured by a camera may provide valuable information to reduce errors. For purposes of the present disclosure, a positioning session (e.g., a period of time in which one or more entities are configured to determine the position of a UE or a target) that is associated with camera-based positioning or camera-aided positioning may be referred to as a camera-based positioning session or a camera-aided positioning session. In some examples, the camera-based positioning and/or the camera-aided positioning may be associated with an absolute position of the UE, a relative position of the UE, an orientation of the UE, or a combination thereof.

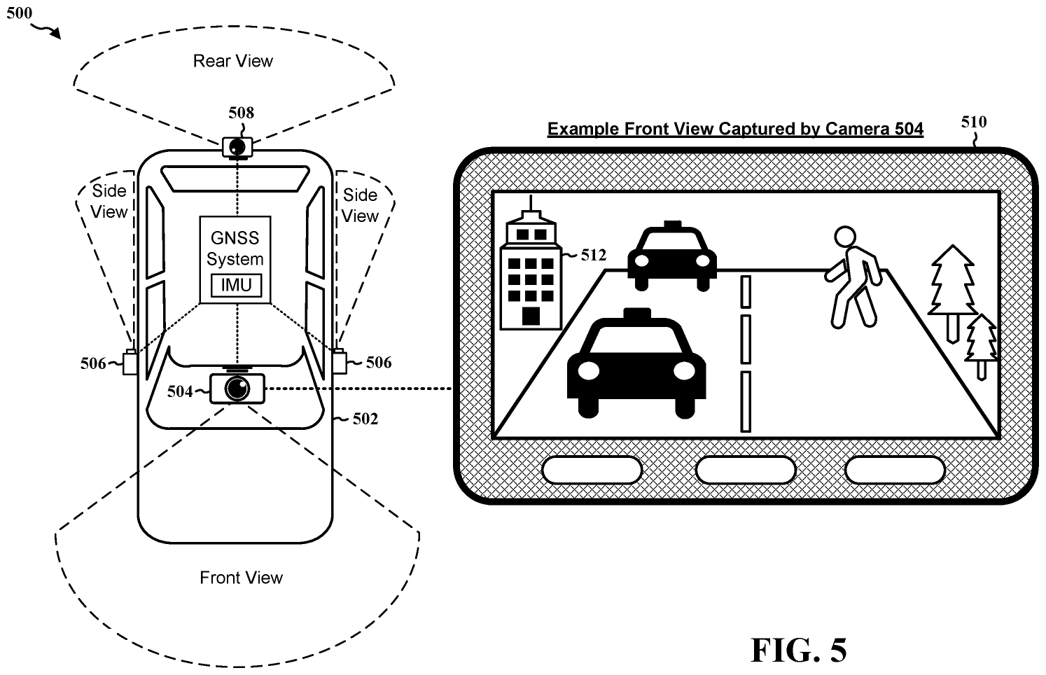

FIG. 5 is a diagram 500 illustrating an example of camera-aided positioning in accordance with various aspects of the present disclosure. A vehicle 502 may be equipped with a GNSS system and a set of cameras, which may include a front camera 504 (for capturing the front view of the vehicle 502), side cameras 506 (for capturing the side views of the vehicle 502), and/or a rear camera 508 (for capturing the rear view of the vehicle 502), etc. In some examples, the GNSS system may further include or be associated with at least one IMU (which may be referred to as a “GNSS+IMU system”). While FIG. 5 uses the vehicle 502 as an example, it is merely for illustration purposes. Aspects presented herein may also apply to other types of transportations (e.g., motorcycles, bicycles, buses, trains, etc.), devices (e.g., UEs on pedestrians), and/or positioning mechanisms/modes (e.g., network-based positioning described in connection with FIG. 4). In addition, for purposes of the present disclosure, a positioning mechanism/mode (e.g., GNSS-based positioning, network-based positioning, etc.) that uses at least one sensor (e.g., an IMU, a camera, etc.) to assist the positioning may be referred to as a “sensor fusion positioning.”

The GNSS system may be used for estimating the location of the vehicle 502 based on receiving GNSS signals transmitted from multiple satellites (e.g., based on performing GNSS-based positioning). However, when the GNSS signals are not available or weak (which may be referred to as a GNSS outage), such as when the vehicle 502 is in an urban area or in a tunnel, the estimated location of the vehicle 502 may become inaccurate. Thus, in some implementations, the set of cameras on the vehicle 502 may be used for assisting the positioning, such as for verifying whether the location estimated by the GNSS system based on the GNSS signals is accurate. For example, as shown at 510, images captured by the front camera 504 of the vehicle 502 may include/identify a specific building 512 (which may also be referred to as a feature) that is with a known location, and the vehicle 502 (or the GNSS system or a positioning engine associated with the vehicle 502) may determine/verify whether the location (e.g., the longitude and latitude coordinates) estimated by the GNSS system is in proximity to the known location of this specific building 512. Thus, with the assistance of the camera(s), the accuracy and reliability of the GNSS-based positioning may be further improved. For purposes of the present disclosure, a GNSS system that is associated with a camera (e.g., capable of performing camera-aided/based positioning) may be referred to as a “GNSS+camera system,” or a “GNSS+IMU+camera system” (if the GNSS system is also associated with/includes at least one IMU). A vision-aided positioning mechanism that is capable of achieving a high-level positioning accuracy (e.g., meeting a defined precision threshold) may be referred to as vision-aided precise positioning (VAPP).

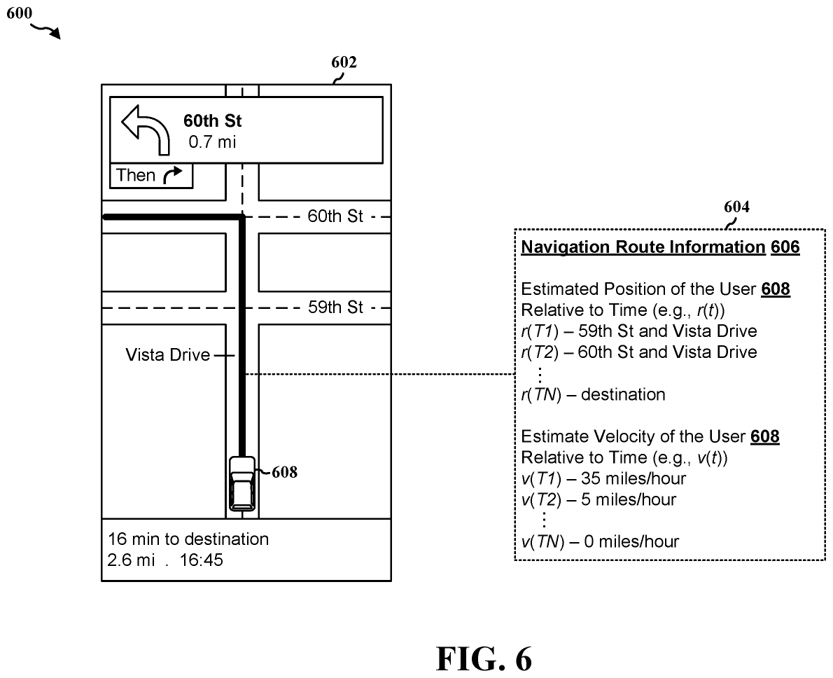

In some examples, a software or an application that accepts positioning related measurements from GNSS chipset(s), sensor(s), and/or camera(s) to estimate the position, the velocity, and/or the altitude of a device (or a target) may be referred to as a positioning engine (PE). Similarly, a positioning engine that is capable of achieving certain high level of accuracy (e.g., a centimeter/decimeter level accuracy) and/or latency may be referred to as a precise positioning engine (PPE). For example, a positioning engine that is capable of performing real-time kinematic positioning (RTK) (e.g., receiving or processing correction data associated with RTK as described in connection with FIG. 6) may be considered as a PPE. Another example of PPE is a positioning engine that is capable of performing precise point positioning (PPP). PPP is a positioning technique that removes or models GNSS system errors to provide a high level of position accuracy from a single receiver.

In some examples, a navigation application/software may refer to an application/software in a user equipment (e.g., a smartphone, an in-vehicle navigation system, a GPS device, etc.) that is capable of providing navigational directions in real time. Over the last few years, users have increasingly relied on navigation applications because they have provided various benefits. For example, navigation applications may provide convenience to users as they enable users to find a way to their destinations, and also allow users to contribute information and mark places of importance thereby generating the most accurate description of a location. In some examples, navigation applications are also capable of providing expert guidance for users, where a navigation application may guide a user to a destination via the best, most direct, or most time-saving routes. For example, a navigation application may obtain the current status of traffic, and then locate a shortest and fastest way for a user to reach a destination, and also provide approximately how long it will take the user to reach the destination. As such, a navigation application may use an Internet connection, map data from a server, and/or a GPS/GNSS navigation system to provide turn-by-turn guided instructions on how to arrive at a given destination.

FIG. 6 is a diagram 600 illustrating an example of a navigation application in accordance with various aspects of the present disclosure. As shown at 602, a navigation application, which may be running on a UE such as a vehicle (e.g., a built-in GPS/GNSS system of the vehicle) or a smartphone, may provide a user (e.g., via a display or an interface) with turn-by-turn directions to a destination and an estimated time to reach the destination based on real-time information. For example, the navigation application may receive/download real-time traffic information, road condition information, local traffic rules (e.g., speed limits), and/or map information/data from a server. Then, the navigation application may calculate a route to the destination based on at least the map information and other available information. The map information may include the map of the area in which the user is traveling, such as the streets, buildings, and/or terrains of the area, or a map that is compatible with the navigation application and GPS/GNSS system. In some examples, the route calculated by the navigation application may be the shortest or the fastest route. For purposes of the present disclosure, information associated with this calculated route may be referred to as navigation route information. For example, navigation route information may include predicted/estimated positions, velocities, accelerations, directions, and/or altitudes of the user at different points in time.

For example, as shown at 604, based on the map information, the speed limit, and the real-time road condition information, the navigation application may generate navigation route information 606 that guides a user 608 to a destination. In some examples, the navigation route information 606 may include the position of the user and velocity of the user relative/respect to time, which may be denoted as \vec{r}(t) and \vec{v}(t), respectively. For example, the navigation application may estimate that at a first point in time (T1), the user may reach a first point/place with certain speed (e.g., the intersection of 59th Street and Vista Drive with a velocity of 35 miles per hour), and at a second point in time (T2), the user may reach a second point/place with certain speed (e.g., the intersection of 80th Street and Vista Drive with a velocity of 15 miles per hour), and up to N^{th} point in time (TN), etc.

In recent years, vehicle manufacturers have been developing vehicles with autonomous driving capabilities. Autonomous driving, which may also be called as self-driving or driverless technology, may refer to the ability of a vehicle to navigate and operate itself without specifying human intervention (e.g., without a human controlling the vehicle). The goal of the autonomous driving is to create vehicles that are capable of perceiving their surroundings, making decisions, and controlling their movements, all without the direct involvement of a human driver.

To achieve or improve the autonomous driving, a vehicle may be specified to use a map (or map data) with detailed information, such as a high-definition (HD) map. An HD map may refer to a highly detailed and accurate digital map designed for use in autonomous driving and advanced driver assistance systems (ADAS). In one example, HD maps may typically include one or more of: (1) geometric information (e.g., precise road geometry, including lane boundaries, curvature, slopes, and detailed 3D models of the surrounding environment), (2) lane-level information (e.g., information about individual lanes on the road, such as lane width, lane type (e.g., driving, turning, or parking lanes), and lane connectivity), (3) road attributes (e.g., data on road features like traffic signs, signals, traffic lights, speed limits, and road markings), (4) topology (e.g., information about the relationships between different roads, intersections, and connectivity patterns), (5) static objects (e.g., locations and details of fixed objects along the road, such as buildings, traffic barriers, and poles), (6) dynamic objects (e.g., real-time or frequently updated data about moving objects, like other vehicles, pedestrians, and cyclists), and/or (7) localization and positioning: precise reference points and landmarks that help in accurate vehicle localization on the map, etc. In some implementations, a HD-map may also include real-time information, such as traffics, obstacles, constructions, road closures, and/or weather conditions of different areas/roads. As HD maps are capable of providing detailed and up-to-date information about the road network, including lane-level data, traffic signs, road markings, and other important features, etc., HD maps may be an important aspect for enabling autonomous vehicles to navigate complex environments and make informed decisions in real-time.

As described in connection with FIGS. 5 and 6, while a precise positioning technology using GNSS and IMU coupling may provide highly accurate location solutions, the IMU bias drifting may degrade the positioning accuracy during a GNSS outage. Such IMU bias may also lead to initial sensor alignment and/or heading ambiguity with a static start. Thus, map(s), such as two-dimensional (2D) map(s), three-dimensional (3D) map(s), HD map(s), street view map(s), etc., may be used (by a positioning device such as a UE or a positioning engine (PE)) for mitigating or reducing errors under such scenarios. For examples, a UE may use maps for positioning and/or for navigations to verify the accuracy of its positioning (for GNSS/network-based positioning). For purposes of the present disclosure, positioning that uses map(s) or map data to improve the accuracy and/or reliability of the positioning may be refer to as “map-aiding positioning” or “map-aided positioning.” On the other hand, positioning that is primarily based on using map(s) may be referred to as “map-based positioning.” In addition, “map(s)” and “map data” may refer to a visual representation or data of an area of land or sea showing physical features (e.g., cities, roads, terrains, etc.), and may be used interchangeably throughout the specification.

While maps (e.g., 2D, 3D, HD, street view maps, etc.) may be beneficial to various positioning technologies (e.g., e.g., for aiding GNSS/network-based positioning), such as by providing additional heading and location constraints for a positioning engine device, inaccurate, incorrect and/or manipulated map data (e.g., from spoofer(s)) may be detrimental to the positioning performance. A “spoof” or “spoofing” may refer to a deceptive practice in which someone or something impersonates or imitates something else, often with the intention of misleading or tricking others. In the context of technology and cybersecurity, a “spoof” or “spoofing” attack may involve falsifying information or disguising the true source of data or communication. A “spoofer” may refer to a person, a device, or an entity that performs a spoof/spoofing attack.

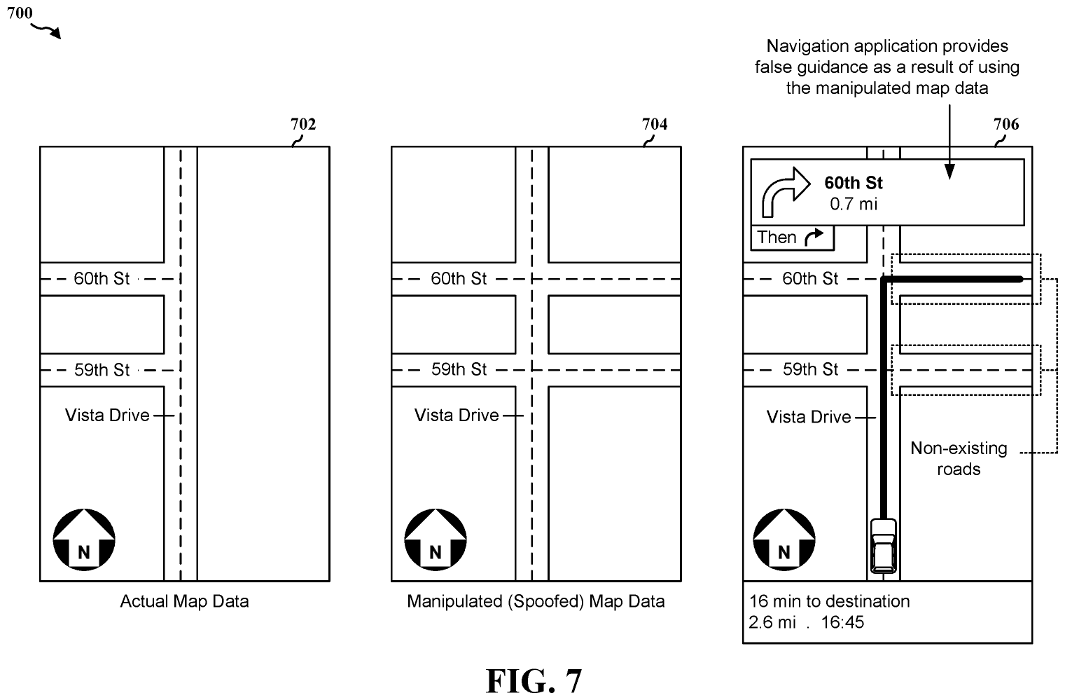

FIG. 7 is a diagram 700 illustrating an example of manipulated (spoofed) map data in accordance with various aspects of the present disclosure. In one example, a spoofer may seed a manipulated map data to a navigation application, causing the navigation application to provide inaccurate (and dangerous) navigation guidance. For example, as shown at 702, an actual map data may show that a road (e.g., the Vista Drive) connects to two roads (the 59^{th} street and the 60^{th} street) on one side. However, as shown at 704, a manipulated map data may show that the road (e.g., the Vista Drive) connects to the two roads (the 59^{th} street and the 60^{th} street) on both sides. Thus, as shown at 706, based on using the manipulated map data, a navigation application may provide false/inaccurate guidance/navigation to a user, such as instructing a user to turn to a non-existing road.

In another example, a spoofer may use street view map data (e.g., HD map data that includes street views) to seed wrong orientations within a location. In some scenarios, location queries (e.g., location requests from a positioning device such as a mobile phone) may go out when a navigation (e.g., an augmented reality (AR) navigation) is first done and the navigation may relaunch when a user points the mobile phone at the ground. So, using orientation information from street view map data may cause misalignment (unintentionally or intentionally). Also, a spoofer may send map data with incorrect heading (e.g., change north to south, cast to west, etc.) to mislead a positing engine with incorrect geometry constraints (e.g., wrong Kalman filter (KF) time, wrong dynamic model, etc.).

Aspects presented herein may improve the accuracy and safety of map-aiding positioning or map-based positioning by enabling a positioning device (e.g., a UE) to verify the integrity of map data, and to avoid map data spoofing events for map-aiding location technologies. In one aspect, a positioning device may be configured to validate a source map and/or a street image to avoid intentional spoofing based on using at least one of: a multi-map source crosscheck, a visual data consistency check (e.g., using at least one camera), a GNSS, IMU, and/or magnetometer sensor consistency check, a radio frequency (RF)-beacon check, and/or a radar-based consistency check, etc. In another aspect, a positioning device may be configured to validate a source map and/or a street image based on a data buffer mechanism, which may minimize visual location data queries (if used opportunistically) and avoid real-time communication latency. In another aspect, a positioning device may be configured to validate a source map and/or a street image by establish map data using sensor(s) of the positioning device, such as obtaining basic knowledge of visited environment(s) and leverage historical data in the past for future usage. In another aspect, a positioning device may be configured to validate a source map and/or a street image using an asset-tracking-based approach.

In one aspect of the present disclosure, a positioning device, which may be a navigation system, a device running a navigation application, a vehicle (e.g., an autonomous vehicle), an on-board unit (OBU) of a vehicle, and/or an autonomous driving system, etc. (collectively as a “UE” hereafter) may be configured to validate source map data (e.g., map(s) or street view(s) from a first server or stored in a database of the UE) to avoid intentional/unintentional spoofing by comparing the source map data with map(s), image(s), and/or information from another source (e.g., from another map server, from its sensor(s)/camera(s), etc.).

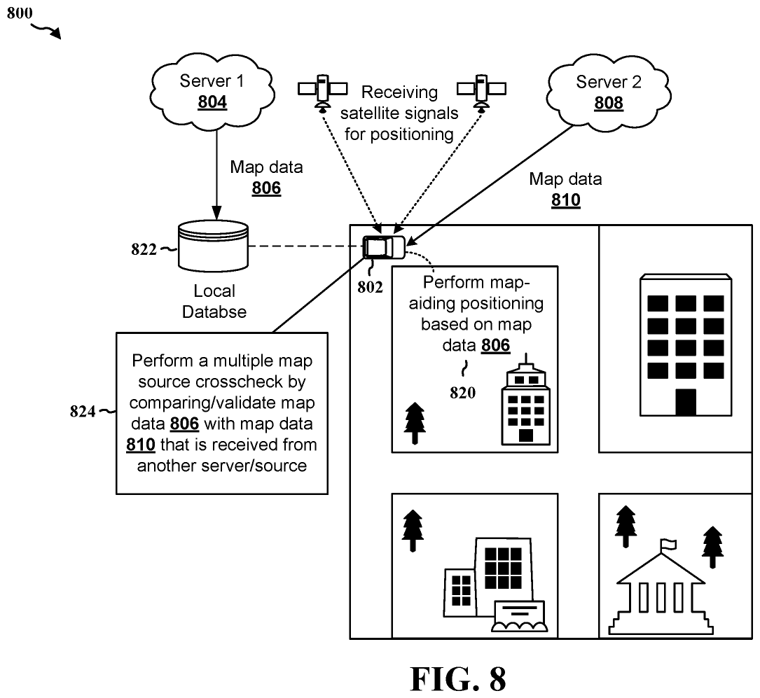

FIG. 8 is a diagram 800 illustrating an example of validating (the authenticity/integrity of) source map data based on a multiple map source crosscheck in accordance with various aspects of the present disclosure. For purposes of the present disclosure, map data may refer to data that include map information. For example, map data may include a set of two-dimensional (2D) maps, a set of three-dimensional (3D) maps, a set of high-definition (HD) maps, a set of street views, or a combination thereof.

As shown at 820, a UE 802 may be performing map-aiding positioning (based on a request from a user, an application, or a network entity), such as performing satellite-based positioning (positioning based on receiving GNSS signals) or network-based positioning (e.g., as described in connection with FIG. 4) and using first map data 806 to assist the satellite/network-based positioning. As shown at 822, the first map data 806 may be from a first source, such as from a first server 804 (server 1) or based on existing map data stored/available at a local database (e.g., at a memory) of the UE 802 (e.g., which may be downloaded/updated from a storage medium such as via a universal serial bus (USB) drive or an optical (CD/DVD) drive, etc.).

In one example, as shown at 824, to validate whether map(s) or street image(s) in the first map data 806 (or from the first server 804) are accurate (e.g., whether they have been spoofed, tampered, or modified, etc.), the UE 802 may compare the first map data 806 (or information in the first map data 806) with map data or information from a second source (e.g., a source that is different from the first source), such as compare with a second map data 810 (or information in the second map data 810) that is obtained from a second server 808 (server 2). Such map data comparison may be referred to as a “multiple map source crosscheck” for purposes of the present disclosure. The comparison between two map data (e.g., between the first map data 806 and the second map data 810) may include comparing the road heading, the road speed limit, the land number, the cross-section geometry, the terrain height, the street name, the landmark validity, the building number, and/or the real-time traffic condition (of specific areas) provided by the two map data. In addition, the first server 804 and the second server 808 may or may not be operated by the same vendor. For example, the first server 804 may be operated by a first vendor and the second server 808 may be operated by a second vendor, or both servers may be operated by the same vendor but located at or using different storage spaces.

Based on the comparison, the UE 802 may determine whether the first map data 806 (or map(s)/street image(s) in the first map data 806) is accurate or authentic. For example, if the similarity between map(s) from the first server 804 and the map(s) from the second server 808 meets or exceeds an accuracy/similarity threshold (as maps from different servers/vendors may have different levels of details/information), the UE 802 may determine that the first map data 806 is likely to be accurate (e.g., has not been spoofed or manipulated). On the other hand, if the similarity is below the accuracy/similarity threshold, the UE 802 may determine that the first map data 806 may contain inaccurate information (e.g., may be spoofed, manipulated, or outdated). For example, if the map for an area in the first map data 806 is as shown at 704 of FIG. 7 and the map for the same area in the second map data 810 is as shown at 702 of FIG. 7, then the UE 802 may determine that the first map data 806 may include inaccurate information (e.g., may be spoofed, manipulated, or outdated).

Based on determining that the first map data 806 may include inaccurate information, depending on the implementations, the UE 802 may discard the first map data 806 (e.g., not using the first map data 806 for the map-aiding positioning or the navigation) and/or re-download the first map data 806 from the first server 804. For example, if the similarity between a map of an area in the first map data 806 and the map of the same area in the second map data 810 does not meet an accuracy threshold, the UE 802 may refrain from using the first map data 806 and use the second map data 810 instead (for the map-aiding positioning or the navigation). In some examples, the UE 802 may also be configured to download a third map data (e.g., map(s)/street view(s) that are found to be inconsistent between the first map data 806 and the second map data 810) from a third source (e.g., a third server/vendor) if available, such that the UE 802 may also verify whether the second map data 810 is the one being spoofed (e.g., protect against the scenario where the second map data 810 is the one being spoofed). In some examples, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use).

Aspects discussed in connection with FIG. 8 may enable a UE to validate source map(s) or street view(s) to avoid intentional spoofing based on the multiple map source crosscheck, where map data from different sources may be used for consistency check. This may also prevent accidental usage of wrong or outdated map. By using maps from different servers/vendors simultaneously, for example, a UE may validate at least the following map information: road heading, road speed limit, land numbers, cross-section geometry, terrain heights, street name, landmark validity, building numbering, real-time traffic conditions, etc.

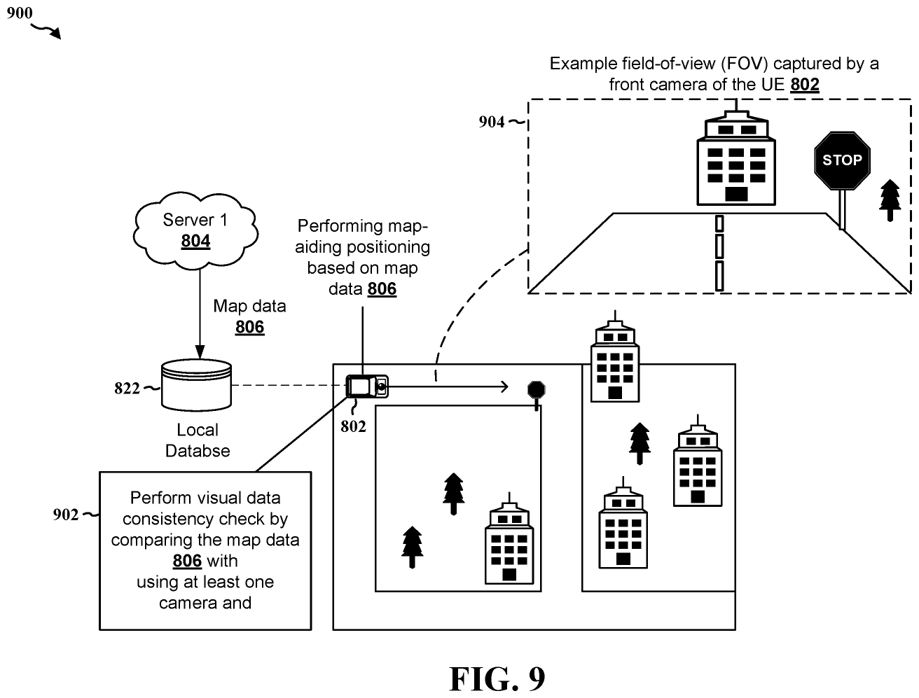

FIG. 9 is a diagram 900 illustrating an example of validating (the authenticity/integrity of) source map data based on a visual data consistency check using at least one camera in accordance with various aspects of the present disclosure. In another example, to verify whether map data used by a UE is accurate (e.g., is not being spoofed or outdated), the UE may be configured to compare the map data (e.g., information in the map data such as street view, sign, landmark, street name, and/or road heading, etc.) with a real-time camera view (CV) content. For example, as shown at 902, the UE 802 may compare information for an area in the first map data 806 (e.g., the locations of building(s), road sign(s), street name(s), etc. of an area) with information in an image or a field-of-view (FOV) captured by at least one camera of the UE 802 for that area (as shown at 904). In some examples, if the first map data 806 includes street views, the comparison may also be based on performing a pixel matching check mechanism for street view(s) from the first map data 806 and the street view(s) captured by the UE 802 (e.g., based on comparing the street view(s) pixel by pixel).

Based on the comparison, the UE 802 may determine whether the first map data 806 (or map(s)/street image(s) in the first map data 806) is accurate or authentic. For example, if the similarity between information in the first map data 806 and information obtained from image(s)/FOVs captured by the camera(s) of the UE 802 meets or exceeds an accuracy/similarity threshold, the UE 802 may determine that the first map data 806 is likely to be accurate (e.g., has not been spoofed or manipulated). On the other hand, if the similarity is below the accuracy/similarity threshold, the UE 802 may determine that the first map data 806 may contain inaccurate information (e.g., may be spoofed, manipulated, or outdated). For example, if the map for an area in the first map data 806 includes a road, a sign and/or a building that does not exist in image(s) captured by the UE 802 for the same area, the UE 802 may determine that the first map data 806 may include inaccurate information (e.g., may be spoofed, manipulated, or outdated).

Similarly, based on determining that the first map data 806 may include inaccurate information, depending on the implementations, the UE 802 may discard the first map data 806 and/or re-download the first map data 806 (e.g., from the first server 804). In some examples, the UE 802 may also download another map data from another server (e.g., download the second map data 810 from the second server 808) and use the new downloaded map data (e.g., the second map data 810) for the map-aiding positioning or the navigation instead. In some examples, as described in connection with FIG. 8, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use).

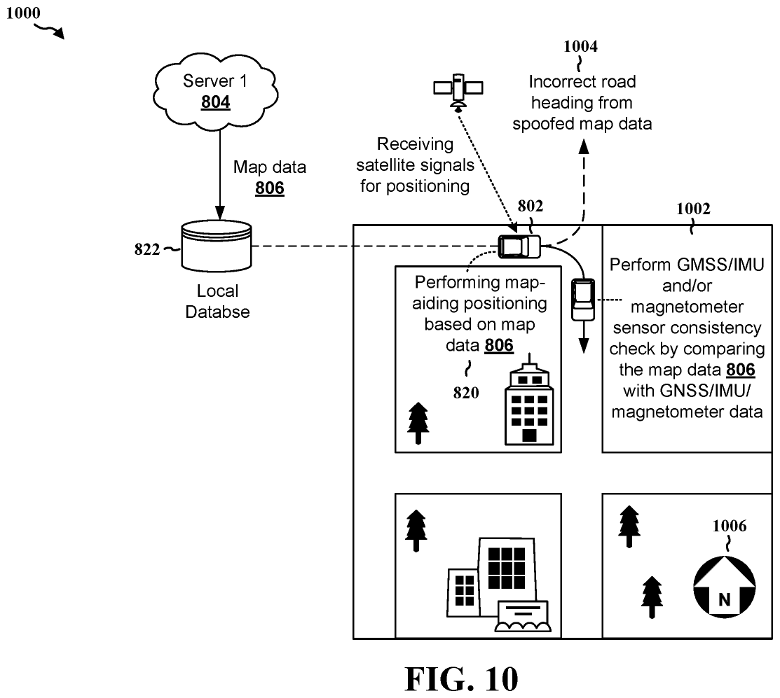

FIG. 10 is a diagram 1000 illustrating an example of validating (the authenticity/integrity of) source map data based on a global navigation satellite system (GNSS)/inertial measurement unit (IMU)/magnetometer sensor consistency check in accordance with various aspects of the present disclosure. An IMU may be a device that is capable of measuring and reporting specific gravity and angular rate of an object to which it is attached. An IMU may typically include gyroscope(s) (e.g., for providing a measure angular rate) and accelerometer(s) (e.g., for providing a measure specific force/acceleration). In one example, to verify whether map data used by a UE is accurate (e.g., is not being spoofed or outdated), the UE may be configured to compare the map data (e.g., information in the map data) with (real-time or recorded) GNSS data, IMU data (gyroscope data and accelerator data), and/or magnetometer sensor data.

As shown at 1002, the UE 802 may compare information from the first map data 806 (e.g., the road headings, direction of maps and roads, etc.) with data/measurements obtained from a GNSS device, an IMU, and/or a magnetometer sensor. For example, the UE 802 may check whether the dynamics of the UE 802 (e.g., the measured movement(s), orientation(s), and/or direction(s) of the UE 802) are consistent with road heading from the map data 806. If there are inconsistencies (e.g., the consistency does not meet an accuracy threshold), the UE 802 may determine that the first map data 806 may include inaccurate information (e.g., may be spoofed, manipulated, or outdated). For example, as shown at 1004, the first map data 806 may be in accurate (or a suspicious map data input may occur) when the UE 802 turns right (indicated by its IMU or GNSS) but the road heading is toward left based on the first map data 806. In another example, as shown at 1006, the UE 802 may also compare the map heading provided by the first map data 806 with its heading direction obtained from a magnetometer (compass) sensor. For example, if the UE 802 is travelling towards south but the first map data 806 indicates that the UE 802 is travelling towards north, the UE 802 may determine that the first map data 806 may include inaccurate information.

Based on the comparison, the UE 802 may determine whether the first map data 806 is accurate or authentic. For example, if the similarity between information in the first map data 806 and data/information obtained from the GNSS/IMU/magnetometer of the UE 802 meets or exceeds an accuracy/similarity threshold, the UE 802 may determine that the first map data 806 is likely to be accurate (e.g., has not been spoofed or manipulated). On the other hand, if the similarity is below the accuracy/similarity threshold, the UE 802 may determine that the first map data 806 may contain inaccurate information (e.g., may be spoofed, manipulated, or outdated). Similarly, based on determining that the first map data 806 may include inaccurate information, depending on the implementations, the UE 802 may discard the first map data 806 and/or re-download the first map data 806 (e.g., from the first server 804). In some examples, the UE 802 may also download another map data from another server (e.g., download the second map data 810 from the second server 808) and use the new downloaded map data (e.g., the second map data 810) for the map-aiding positioning or the navigation instead. In some examples, as described in connection with FIG. 8, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use).

In another example, to verify whether map data used by a UE is accurate (e.g., is not being spoofed or outdated), the UE may be configured to perform a radio frequency (RF)-beacon check by comparing locations of one or more entities that are capable of transmitting wireless signals (e.g., cell towers, Wi-Fi® transmitters, etc.) provided by the map data with its own estimated locations for these entities. For example, the first map data 806 (e.g., HD map data, street view map data, etc.) may include locations of a plurality of Wi-Fi/cell transmitters (e.g., base stations, transmission reception points (TRPs), cell towers, etc.). As such, the UE 802 may be configured to measure signals transmitted from at least one Wi-Fi/cell transmitter (with a known location in the first map data 806), and the UE 802 may estimate the location (e.g., a relative location, an absolute location, etc.) of the at least one Wi-Fi/cell transmitter based on the measurements (e.g., the UE 802 may measure angle-of-arrival (AoA) of the signal, time-of-flight (ToF) of the signal, the direction of the signal, etc.). Then, after estimating/determining the location of the at least one Wi-Fi/cell transmitter, the UE 802 may compare its estimated location for the at least one Wi-Fi/cell transmitter with the location of the at least one Wi-Fi/cell transmitter provided by the first map data 806. If there are inconsistencies (e.g., the consistency does not meet an accuracy threshold), the UE 802 may determine that the first map data 806 may include inaccurate information (e.g., may be spoofed, manipulated, or outdated). For example, if a cell tower location on the map is inconsistent with the cell tower location from a UE handshake, the map may be inaccurate.

Based on the comparison, the UE 802 may determine whether the first map data 806 is accurate or authentic. For example, if the similarity between transmitter locations in the first map data 806 and the transmitter locations estimated by the UE 802 meets or exceeds an accuracy/similarity threshold, the UE 802 may determine that the first map data 806 is likely to be accurate. On the other hand, if the similarity is below the accuracy/similarity threshold, the UE 802 may determine that the first map data 806 may contain inaccurate information (e.g., may be spoofed, manipulated, or outdated). If the first map data 806 includes inaccurate information, depending on the implementations, the UE 802 may discard the first map data 806 and/or re-download the first map data 806 (e.g., from the first server 804). In some examples, the UE 802 may also download another map data from another server (e.g., download the second map data 810 from the second server 808) and use the new downloaded map data (e.g., the second map data 810) for the map-aiding positioning or the navigation instead. In some examples, as described in connection with FIG. 8, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use).

In another example, to verify whether map data used by a UE is accurate (e.g., is not being spoofed or outdated), the UE may be configured to perform a radar-based consistency check by comparing locations of one or more objects in the map data with locations of objects detected by the UE using at least one radar. In some examples, reflection, refraction, and/or scattering characteristic obtained from a radar (e.g., an RF radar, a (light detection and ranging) Lidar, an ultra-sound radar, an ultrawide band (UWB) radar, etc.) may be helpful to distinguish the consistency between real-time (image) source and external (street view image) source. For example, referring back to FIG. 9, if the first map data 806 indicates there is a stop sign in front of the UE 802, but the radar of the UE 802 senses there is no object in front of the UE 802, the UE 802 may determine that the first map data 806 may include inaccurate information (e.g., may be spoofed, manipulated, or outdated). In another example, the UE 802 may use Lidar or camera information to determine if there is a flat or mostly consistent surface that would be inconsistence with the image expectation.

Based on the comparison, the UE 802 may determine whether the first map data 806 is accurate or authentic. For example, if a set of object in the first map data 806 is also detected the UE 802 (e.g., with the detection rate meets or exceeds an accuracy/similarity threshold, such as 80% of objects are detected), the UE 802 may determine that the first map data 806 is likely to be accurate. On the other hand, if the detection rate is below the accuracy/similarity threshold (e.g., a number/percentage of objects provided by the first map data 806 are not detected by the UE 802), the UE 802 may determine that the first map data 806 may contain inaccurate information (e.g., may be spoofed, manipulated, or outdated). Similarly, if the first map data 806 includes inaccurate information, depending on the implementations, the UE 802 may discard the first map data 806 and/or re-download the first map data 806 (e.g., from the first server 804). In some examples, the UE 802 may also download another map data from another server (e.g., download the second map data 810 from the second server 808) and use the new downloaded map data (e.g., the second map data 810) for the map-aiding positioning or the navigation instead. In some examples, as described in connection with FIG. 8, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use).

In another aspect of the present disclosure, to improve the performance, reliability, and latency of map-aiding positioning, a UE may be configured to buffer an amount of map data based on characteristic(s) of the UE. In some scenarios, communication latency may be a challenge in a real-time implementation if a UE (e.g., the UE 802) is specified to send a request up to a server (e.g., the first server 804) every time to retrieve map data (e.g., the first map data 806). Thus, to speed up the process of receiving map data, the UE may be configured with a data buffer mechanism that enables the UE to buffer map data based on at least on characteristic of the UE, thereby minimizing visual location data queries from the UE (e.g., reducing number of map data download/update requests send by the UE to the server).

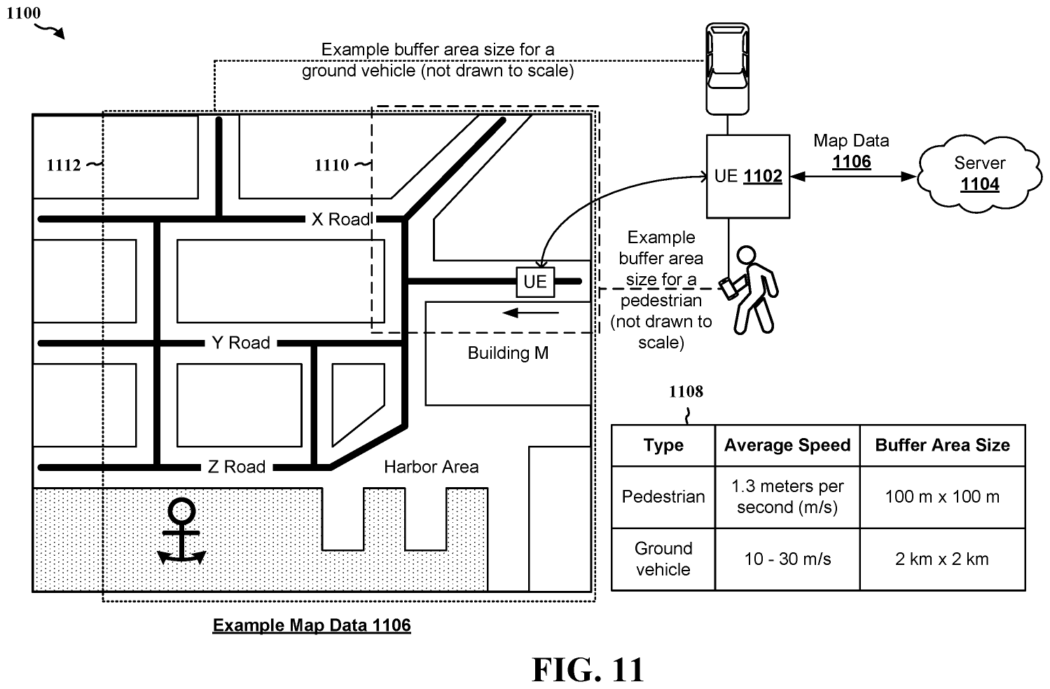

FIG. 11 is a diagram 1100 illustrating an example of a data buffer mechanism in accordance with various aspects of the present disclosure. A UE 1102 (a positioning device, a navigation system, a device running a navigation application, a vehicle or an on-board unit (OBU) of the vehicle, an autonomous vehicle, and/or an autonomous driving system, etc.) may download map data 1106 form a server 1104. In one example, to improve the performance, reliability, and latency of map-aiding positioning or navigation, the UE 1102 may be configured to buffer additional/more data within a proximity area of map data based on the modality (type), dynamics, and/or capabilities of the UE 1102. For example, as shown at 1108, the UE 1102 may be configured to buffer different area size (e.g., different amount of map data) based on the modality (e.g., type), speed, and/or capabilities of the UE 1102. If the UE 1102 is used in association with a pedestrian (e.g., a smart watch, a handheld positioning device, etc.), moving within a first speed range (e.g., between 0.1 meters per second (m/s) to 2 m/s), or has a lower processing/downloading capability or storage, etc., the UE 1102 may be specified to buffer a first (smaller) area size (e.g., 100 meters×100 meters), such as shown at 1110. On the other hand, if the UE 1102 is used in association with a ground vehicle (e.g., a vehicle navigation system, an OBU, etc.), moving within a second speed range (e.g., between 2-50 m/s), or has a higher processing/downloading capability or storage, etc., the UE 1102 may be specified to buffer a second (larger) area size (e.g., 2 kilometers×2 kilometers), such as shown at 1112. In some implementations, the UE 1102 may also be able to download map data that is beyond the buffer area size, but these data beyond the proximity area may be down-sampled (e.g., may include less information and/or resolution to reduce the file size). In some examples, the buffer area size may also be dynamically allocated for the UE 1102 based on the motion profile of the UE 1102. For example, different buffer area sizes may be configured for a pedestrian for running and walking, or for different types of ground vehicles (e.g., bikes, motorcycles, car driving in downtown, car cruising in highway, etc.).

In another aspect of the present disclosure, to improve the performance, reliability, and latency of map-aiding positioning, a UE may be configured to establish its own map data using at least one sensor of the UE (e.g., camera(s), radar(s), Lidar(s), IMU(s), magnetometer(s), and/or GNSS device(s), etc.). By enable the UE to establish a UE local map database from its own sensor(s), the UE may obtain some basic knowledge of a visited environment, leverage historical sensor data/map data in the past for future usage, and/or use the local map database to verify the integrity of the map data from a server (e.g., as described in connection with FIG. 8).

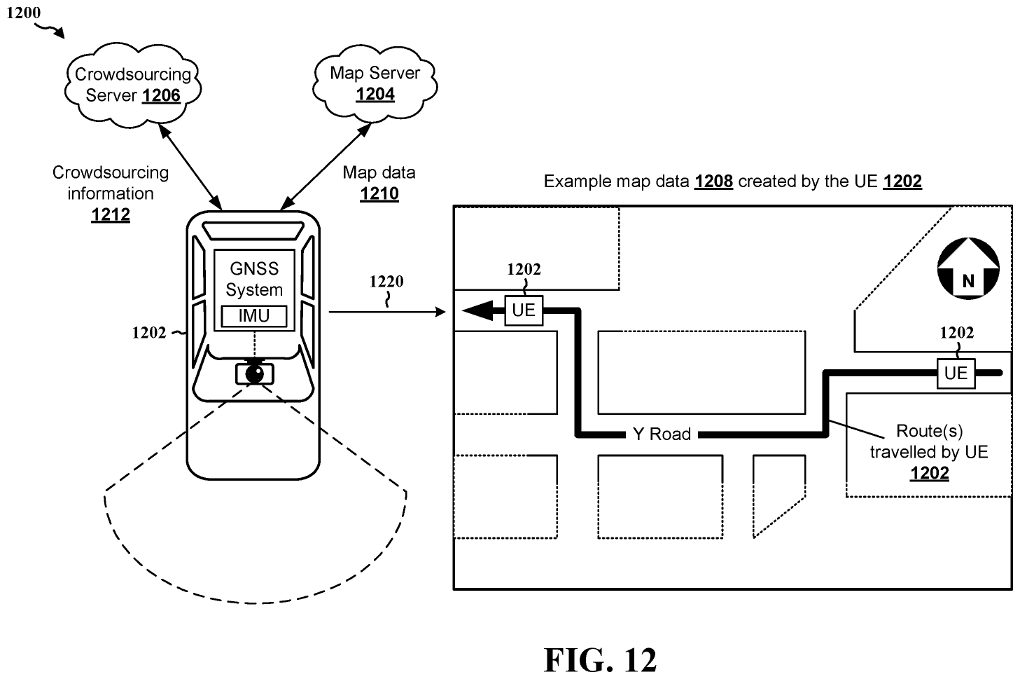

FIG. 12 is a diagram 1200 illustrating an example of a UE establishing map data using at least one sensor in accordance with various aspects of the present disclosure. In one example, as shown at 1220, while a UE 1202 (a positioning device, a navigation system, a device running a navigation application, a vehicle or an on-board unit (OBU) of the vehicle, an autonomous vehicle, and/or an autonomous driving system, etc.) is moving through an area, the UE 1202 may build map data 1208 for that area based information/measurement obtained from its sensor(s). For example, image(s) captured by the camera(s) of the UE 1202 may be used for identifying the surrounding of the UE 1202 (e.g., buildings, roads, obstacles, road signs, etc.), position(s)/direction(s) provided by the GNSS device/IMU/magnetometer of the UE 1202 may be used for identifying routes travelled by the UE 1202, and/or distance of various objects (e.g., distance of buildings and objects around the UE 1202) detect by the radar/Lidar/RF sensor of the UE 1202 may be used for identifying the width/contour of a road, etc. In some examples, such process may be called “simultaneous localization and mapping (SLAM),” which may refer to a method used for a device (e.g., an autonomous vehicle) to build a map and localize the device in that map at the same time. Thus, SLAM algorithms may enable a device to map out unknown environments.

In some implementations, the map data 1208 created by the UE 1202 for an area may be used for verifying the integrity of map data 1210 downloaded from a map server 1204 for that area, such as described in connection with FIG. 8. For example, the UE 1202 may compare the map data 1208 created by the UE 1202 with the map data 1210 from the map server 1204. If there are inconsistency between the two map data (e.g., the accuracy/consistency level does not meet an accuracy/consistency threshold), the UE 1202 may determine that the map data 1210 may include inaccurate information (e.g., the map data 1210 is spoofed or outdated, etc.).

In some implementations, information (e.g., information detected by the sensor(s) of the UE) beyond typical map data (e.g., roads, structures, and their distances, etc.) may also be used by the UE 1202 to infer its location. For example, local weather detected by the UE 1202 (e.g., based on using a camera or a barometer, etc.), RF signature(s) detected by the UE 1202 (e.g., via a transceiver or wireless communication module), and/or real-time solar shadow (of objects or the UE 1202) may be used by the UE 1202 to estimate its location (e.g., an absolute location or a relative location from another object, etc.).

In some examples, the UE 1202 may also provide information detected by the sensor(s) of the UE 1202 to a crowdsourcing server 1206 (which may be referred to as crowdsourcing information 1212), and/or receive the crowdsourcing information 1212 from the crowdsourcing server 1206. Crowdsourcing may refer to a mechanism that involves a server obtaining information from a large group of entities, often from an online community or a “crowd.” Then, the server analyzes and leverages the obtained information and distribute the analyzed/leveraged information to other individual entities (typically to achieve a specific goal or to solve a particular problem). For example, the crowdsourcing information 1212 may include the map data 1208, local meteorological weather (e.g., temperature, humility, air pressure, etc.), space weather (e.g., total electron content (TEC), scintillation, ionospheric delay, tropospheric delay, etc.), geomagnetic field, etc. (location specific that may be saved for location database). In other examples, the crowdsourcing information 1212 may include information related to RF environment(s) (e.g., nearby Wi-Fi routers, Bluetooth®, UWB, FM/AM radio, etc.) are also their related locations. In some examples, for autonomous driving vehicles/navigations, the road(s) driven by a UE may be collected and saved into a map to create a multiple user-explored map (e.g., users moving throughout an area provide the map data they established to create a whole/complete map data for that area). This may be applicable considering a large number of drivers use their car for daily commute so their routes may be relatively similar. This multiple user-explored map may also be used to verify the integrity of map data (e.g., the first map data 806) downloaded form a server (e.g., the first server 804), such as described in connection with FIG. 8.

In another aspect of the present disclosure, the SLAM algorithms mentioned above may also be used for RF-based device asset tracking. For example, to find a radio-frequency identification (RFID) tag (e.g., an RF emitting device that is designed to emit RF signals to enable its location to be detected by a tracking device), a tracking device may be configured to build a SLAM map locally on the tracking device to provide a better experience of where the RFID tag (or the item attached to the RFID tag) may be located in a multi-level or multi-room scenarios. A typical tracking device may be configured to find an RFID tag based on RF signal measurement (e.g., field strength horizontally). However, by building a tracking device to build a SLAM map while the tracking device is moving, a local map including visual information (obtained from camera(s) of the tracking device) or RF signatures may be established so that the RFID tag finding process may be optimized with more image map-aiding information. In addition, visual data (obtained from camera(s) of the tracking device) correlated to RF signatures may be integrated together into a specified/special environment mapping. For example, when placing an RFID tag, the nearby image(s) may become important to provide as rich as possible environment information round the “target” (e.g., the RFID tag).

Aspects presented herein are directed to techniques for dealing with spoofing issues with respect to map data in map-based or map-aiding location technologies. Aspects presented herein include the following aspects/features: 1) Validate source map/street image to avoid intentional spoofing: multi-map source crosscheck, visual data consistency check using camera, GNSS/IMU and magnetometer sensor consistency check, RF-beacon check Radar-based consistency check, etc.; 2) Data buffer mechanism: to minimize visual location data queries (if use opportunistically), which avoid real-time communication latency; 3) Establish map data from UE's own sensor to get some basic knowledge of the visited environment and/or to leverage historical data in the past for future usage; and 4) SLAM-based approach for RFID tag finding. As such, aspects presented herein may prevent outdated or incorrect map data usage to mislead existing positioning solution, prevent people from using commercial/public street view data to spoof orientations within a location, prevent spoofers from injecting incorrect (manipulated) map data to mis-guide the positioning engine (PE) geometry constrains, and/or to avoid intentionally calibrated or encrypted map (e.g., maps in certain countries for purposes of security).

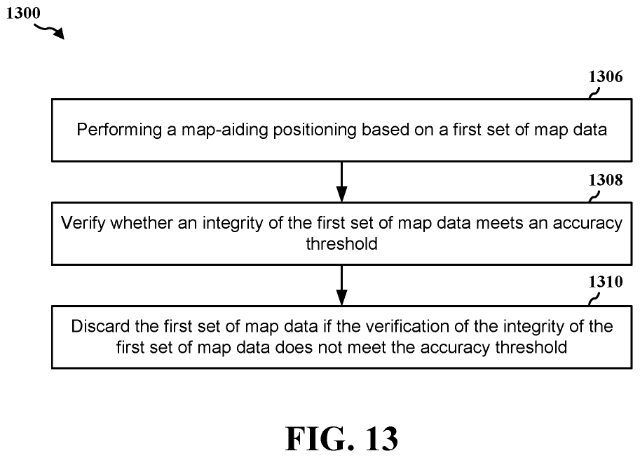

FIG. 13 is a flowchart 1300 of a method of wireless communication. The method may be performed by a UE (e.g., the UE 104, 404, 802, 1102, 1202; the vehicle 502; the apparatus 1504). The method may enable the UE to verify the integrity of map data, thereby improving the accuracy and safety of map-aiding positioning and/or map-based positioning.

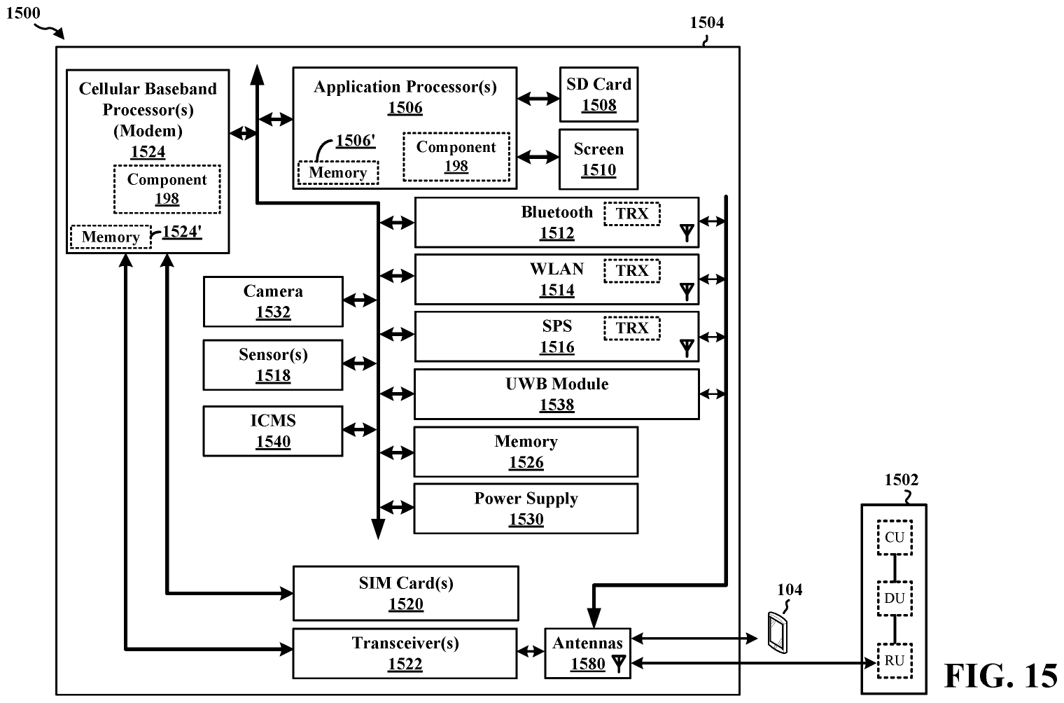

At 1306, the UE may perform map-aiding positioning based on a first set of map data, such as described in connection with FIGS. 8 to 10. For example, as discussed in connection with 820 of FIG. 8, the UE 802 may perform map-aiding positioning based on map data 806. The map-aiding positioning may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

At 1308, the UE may verify whether an integrity of the first set of map data meets an accuracy threshold, such as described in connection with FIGS. 8 to 10. For example, as discussed in connection with 824 of FIG. 8, to validate whether map(s) or street image(s) in the first map data 806 (or from the first server 804) are accurate (e.g., whether they have been spoofed, tampered, or modified, etc.), the UE 802 may compare the first map data 806 (or information in the first map data 806) with map data or information from a second source (e.g., a source that is different from the first source), such as compare with a second map data 810 (or information in the second map data 810) that is obtained from a second server 808 (server 2). Based on the comparison, the UE 802 may determine whether the first map data 806 (or map(s)/street image(s) in the first map data 806) is accurate or authentic. For example, if the similarity between map(s) from the first server 804 and the map(s) from the second server 808 meets or exceeds an accuracy/similarity threshold (as maps from different servers/vendors may have different levels of details/information), the UE 802 may determine that the first map data 806 is likely to be accurate (e.g., has not been spoofed or manipulated). On the other hand, if the similarity is below the accuracy/similarity threshold, the UE 802 may determine that the first map data 806 may contain inaccurate information (e.g., may be spoofed, manipulated, or outdated). The verification of the integrity of the first set of map data may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

At 1310, the UE may discard the first set of map data if the verification of the integrity of the first set of map data does not meet the accuracy threshold, such as described in connection with FIGS. 8 to 10. For example, as discussed in connection with FIG. 8, based on determining that the first map data 806 may include inaccurate information, depending on the implementations, the UE 802 may discard the first map data 806 (e.g., not using the first map data 806 for the map-aiding positioning or the navigation) and/or re-download the first map data 806 from the first server 804. The discarding of the first set of map may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

In one example, the UE may receive an indication to perform the map-aiding positioning, where to perform the map-aiding positioning, the UE may perform the map-aiding positioning further based on the indication to perform the map-aiding positioning, such as described in connection with FIGS. 8 to 10. For example, as discussed in connection with 820 of FIG. 8, the UE 802 may be performing map-aiding positioning (based on a request from a user, an application, or a network entity), such as performing satellite-based positioning (positioning based on receiving GNSS signals) or network-based positioning (e.g., as described in connection with FIG. 4) and using first map data 806 to assist the satellite/network-based positioning. The reception of the indication may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

In another example, the UE may download the first set of map data prior to the performance of the map-aiding positioning, and to perform the map-aiding positioning based on the first set of map data, the UE may perform the map-aiding positioning based on the downloaded first set of map data, such as described in connection with FIGS. 8 to 10. For example, as discussed in connection with 822 of FIG. 8, the first map data 806 may be from a first source, such as from a first server 804 (server 1) or based on existing map data stored at a local database (e.g., at a memory) of the UE 802 (e.g., downloaded/updated from a storage medium such as via a universal serial bus (USB) drive or an optical (CD/DVD) drive, etc.). The downloading of the first set of map may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15. In some implementations, the UE may re-download the first set of map data or reporting results of the verification if the verification of the integrity of the first set of map data does not meet the accuracy threshold.

In another example, the first set of map data includes: a set of two-dimensional (2D) map data, a set of three-dimensional (3D) map data, a set of high-definition (HD) map data, a set of street views, or a combination thereof.

In another example, the UE may output an indication of the discarded first set of map data if the verification of the integrity of the first set of map data does not meet the accuracy threshold, such as described in connection with FIGS. 8 to 10. For example, as discussed in connection with FIG. 8, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use). The outputting of the indication may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15. In some implementations, to output the indication of the discarded first set of map data, the UE may transmit the indication of the discarded first set of map data, or store the indication of the discarded first set of map data.

In another example, to verify whether the integrity of the first set of map data meets the accuracy threshold, the UE may compare the first set of map data with a second set of map data from a different source, and identify the integrity of the first set of map data does not meet the accuracy threshold if the comparison between the first set of map data and the second set of map data shows an indication of inconsistency above a consistency threshold. In some implementations, to compare the first set of map data with the second set of map data, the UE may compare at least one of a road heading, a road speed limit, a land number, a cross-section geometry, a terrain height, a street name, a landmark validity, a building number, or a real-time traffic condition between the first set of map data and the second set of map data. In some implementations, the second set of map data may be from a local database of the UE, and the UE may establish the second set of map data using at least one sensor of the UE.

In another example, to verify whether the integrity of the first set of map data meets the accuracy threshold, the UE may compare the first set of map data with a set of images captured by at least one camera of the UE, and identify the integrity of the first set of map data does not meet the accuracy threshold if the comparison between the first set of map data and the set of images shows an indication of inconsistency above a consistency threshold. In some implementations, the set of images may correspond to a real-time CV or a real-time visual scan captured by the at least one camera of the UE.

In another example, to verify whether the integrity of the first set of map data meets the accuracy threshold, the UE may compare a first UE dynamic derived from the first set of map data with a second UE dynamic derived from real-time GNSS data or from IMU data, and identify the integrity of the first set of map data does not meet the accuracy threshold if the comparison between the first UE dynamic and the second UE dynamic shows an indication of inconsistency above a consistency threshold.

In another example, to verify whether the integrity of the first set of map data meets the accuracy threshold, the UE may compare a first heading of the UE derived from the first set of map data with a second heading of the UE derived from a magnetometer, and identify the integrity of the first set of map data does not meet the accuracy threshold if the comparison between the first heading of the UE and the second heading of the UE shows an indication of inconsistency above a consistency threshold.

In another example, to verify whether the integrity of the first set of map data meets the accuracy threshold, the UE may compare a first set of locations of a set of transmitters derived from the first set of map data with a second set of locations of the set of transmitters derived from at least one communication between the UE and the set of transmitters, and identify the integrity of the first set of map data does not meet the accuracy threshold if the comparison between the first set of locations and the second set of locations shows an indication of inconsistency above a consistency threshold. In some implementations, the set of transmitters includes: a set of Wi-Fi transmitters, a set of TRPs, a set of cell towers, or a combination thereof.

In another example, to verify whether the integrity of the first set of map data meets the accuracy threshold, the UE may compare a first set of locations of a set of objects derived from the first set of map data with a second set of locations of the set of objects derived from at least one radio detection and ranging (radar) sensor, and identify the integrity of the first set of map data does not meet the accuracy threshold if the comparison between the first set of locations and the second set of locations shows an indication of inconsistency above a consistency threshold. In some implementations, the at least one radar sensor includes: at least one RF radar sensor, at least one Lidar sensor, at least one ultra-sound radar sensor, at least one UWB radar sensor, or a combination thereof.

In another example, the UE may prioritize a first subset of map data and a second subset of map data in the first set of map data for downloading or buffering based on a modality of the UE, and download or buffer the first subset of map data and the second subset of map data based on the prioritization. In some implementations, the first subset of map data may correspond to a defined proximity area of the UE and the second subset of map data may correspond to areas outside the defined proximity area, and the first subset of map data may be prioritized over the second subset of map data. In some implementations, the second subset of map data may be down-sampled.

In another example, the UE may associate a tracking device or an object with a set of visual features surrounding the tracking device or the object, compare the set of visual features with at least one feature in the first set of map data, and locate the tracking device or the object based on the comparison of the set of visual features with the at least one feature in the first set of map data.

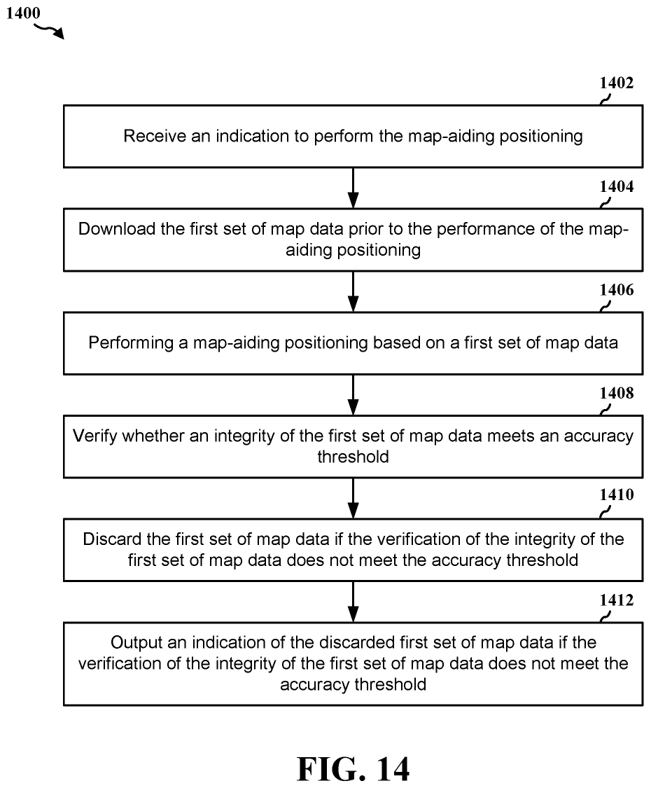

FIG. 14 is a flowchart 1400 of a method of wireless communication. The method may be performed by a UE (e.g., the UE 104, 404, 802, 1102, 1202; the vehicle 502; the apparatus 1504). The method may enable the UE to verify the integrity of map data, thereby improving the accuracy and safety of map-aiding positioning and/or map-based positioning.

At 1406, the UE may perform map-aiding positioning based on a first set of map data, such as described in connection with FIGS. 8 to 10. For example, as discussed in connection with 820 of FIG. 8, the UE 802 may perform map-aiding positioning based on map data 806. The map-aiding positioning may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

At 1408, the UE may verify whether an integrity of the first set of map data meets an accuracy threshold, such as described in connection with FIGS. 8 to 10. For example, as discussed in connection with 824 of FIG. 8, to validate whether map(s) or street image(s) in the first map data 806 (or from the first server 804) are accurate (e.g., whether they have been spoofed, tampered, or modified, etc.), the UE 802 may compare the first map data 806 (or information in the first map data 806) with map data or information from a second source (e.g., a source that is different from the first source), such as compare with a second map data 810 (or information in the second map data 810) that is obtained from a second server 808 (server 2). Based on the comparison, the UE 802 may determine whether the first map data 806 (or map(s)/street image(s) in the first map data 806) is accurate or authentic. For example, if the similarity between map(s) from the first server 804 and the map(s) from the second server 808 meets or exceeds an accuracy/similarity threshold (as maps from different servers/vendors may have different levels of details/information), the UE 802 may determine that the first map data 806 is likely to be accurate (e.g., has not been spoofed or manipulated). On the other hand, if the similarity is below the accuracy/similarity threshold, the UE 802 may determine that the first map data 806 may contain inaccurate information (e.g., may be spoofed, manipulated, or outdated). The verification of the integrity of the first set of map data may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

At 1410, the UE may discard the first set of map data if the verification of the integrity of the first set of map data does not meet the accuracy threshold, such as described in connection with FIGS. 8 to 10. For example, as discussed in connection with FIG. 8, based on determining that the first map data 806 may include inaccurate information, depending on the implementations, the UE 802 may discard the first map data 806 (e.g., not using the first map data 806 for the map-aiding positioning or the navigation) and/or re-download the first map data 806 from the first server 804. The discarding of the first set of map may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

In one example, as shown at 1402, the UE may receive an indication to perform the map-aiding positioning, where to perform the map-aiding positioning, the UE may perform the map-aiding positioning further based on the indication to perform the map-aiding positioning, such as described in connection with FIGS. 8 to 10. For example, as discussed in connection with 820 of FIG. 8, the UE 802 may be performing map-aiding positioning (based on a request from a user, an application, or a network entity), such as performing satellite-based positioning (positioning based on receiving GNSS signals) or network-based positioning (e.g., as described in connection with FIG. 4) and using first map data 806 to assist the satellite/network-based positioning. The reception of the indication may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15.

In another example, as shown at 1404, the UE may download the first set of map data prior to the performance of the map-aiding positioning, and to perform the map-aiding positioning based on the first set of map data, the UE may perform the map-aiding positioning based on the downloaded first set of map data, such as described in connection with FIGS. 8 to 10. For example, as discussed in connection with 822 of FIG. 8, the first map data 806 may be from a first source, such as from a first server 804 (server 1) or based on existing map data stored at a local database (e.g., at a memory) of the UE 802 (e.g., downloaded/updated from a storage medium such as via a universal serial bus (USB) drive or an optical (CD/DVD) drive, etc.). The downloading of the first set of map may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15. In some implementations, the UE may re-download the first set of map data or reporting results of the verification if the verification of the integrity of the first set of map data does not meet the accuracy threshold.

In another example, as shown at 1412, the UE may output an indication of the discarded first set of map data if the verification of the integrity of the first set of map data does not meet the accuracy threshold, such as described in connection with FIGS. 8 to 10. For example, as discussed in connection with FIG. 8, the UE 802 may also output an indication of the inaccuracy or the discarded first map data 806 if the first map data does not meet the accuracy/similarity threshold, such as by transmitting the indication of the inaccurate/discarded first map data 806 to a server or another entity informing the potential inaccuracy/spoofing event, or storing the indication of the inaccurate/discarded first map data 806 in a memory/storage device as a record (e.g., for future use). The outputting of the indication may be performed by, e.g., the map-aiding positioning component 198, the camera 1532, the one or more sensors 1518, the transceiver(s) 1522, the cellular baseband processor(s) 1524, and/or the application processor(s) 1506 of the apparatus 1504 in FIG. 15. In some implementations, to output the indication of the discarded first set of map data, the UE may transmit the indication of the discarded first set of map data, or store the indication of the discarded first set of map data.

In another example, the first set of map data includes: a set of 2D map data, a set of 3D map data, a set of HD map data, a set of street views, or a combination thereof.

In another example, to verify whether the integrity of the first set of map data meets the accuracy threshold, the UE may compare the first set of map data with a second set of map data from a different source, and identify the integrity of the first set of map data does not meet the accuracy threshold if the comparison between the first set of map data and the second set of map data shows an indication of inconsistency above a consistency threshold. In some implementations, to compare the first set of map data with the second set of map data, the UE may compare at least one of a road heading, a road speed limit, a land number, a cross-section geometry, a terrain height, a street name, a landmark validity, a building number, or a real-time traffic condition between the first set of map data and the second set of map data. In some implementations, the second set of map data may be from a local database of the UE, and the UE may establish the second set of map data using at least one sensor of the UE.

In another example, to verify whether the integrity of the first set of map data meets the accuracy threshold, the UE may compare the first set of map data with a set of images captured by at least one camera of the UE, and identify the integrity of the first set of map data does not meet the accuracy threshold if the comparison between the first set of map data and the set of images shows an indication of inconsistency above a consistency threshold. In some implementations, the set of images may correspond to a real-time CV or a real-time visual scan captured by the at least one camera of the UE.

In another example, to verify whether the integrity of the first set of map data meets the accuracy threshold, the UE may compare a first UE dynamic derived from the first set of map data with a second UE dynamic derived from real-time GNSS data or from IMU data, and identify the integrity of the first set of map data does not meet the accuracy threshold if the comparison between the first UE dynamic and the second UE dynamic shows an indication of inconsistency above a consistency threshold.

In another example, to verify whether the integrity of the first set of map data meets the accuracy threshold, the UE may compare a first heading of the UE derived from the first set of map data with a second heading of the UE derived from a magnetometer, and identify the integrity of the first set of map data does not meet the accuracy threshold if the comparison between the first heading of the UE and the second heading of the UE shows an indication of inconsistency above a consistency threshold.

In another example, to verify whether the integrity of the first set of map data meets the accuracy threshold, the UE may compare a first set of locations of a set of transmitters derived from the first set of map data with a second set of locations of the set of transmitters derived from at least one communication between the UE and the set of transmitters, and identify the integrity of the first set of map data does not meet the accuracy threshold if the comparison between the first set of locations and the second set of locations shows an indication of inconsistency above a consistency threshold. In some implementations, the set of transmitters includes: a set of Wi-Fi transmitters, a set of TRPs, a set of cell towers, or a combination thereof.

In another example, to verify whether the integrity of the first set of map data meets the accuracy threshold, the UE may compare a first set of locations of a set of objects derived from the first set of map data with a second set of locations of the set of objects derived from at least one radio detection and ranging (radar) sensor, and identify the integrity of the first set of map data does not meet the accuracy threshold if the comparison between the first set of locations and the second set of locations shows an indication of inconsistency above a consistency threshold. In some implementations, the at least one radar sensor includes: at least one RF radar sensor, at least one Lidar sensor, at least one ultra-sound radar sensor, at least one UWB radar sensor, or a combination thereof.

In another example, the UE may prioritize a first subset of map data and a second subset of map data in the first set of map data for downloading or buffering based on a modality of the UE, and download or buffer the first subset of map data and the second subset of map data based on the prioritization. In some implementations, the first subset of map data may correspond to a defined proximity area of the UE and the second subset of map data may correspond to areas outside the defined proximity area, and the first subset of map data may be prioritized over the second subset of map data. In some implementations, the second subset of map data may be down-sampled.

In another example, the UE may associate a tracking device or an object with a set of visual features surrounding the tracking device or the object, compare the set of visual features with at least one feature in the first set of map data, and locate the tracking device or the object based on the comparison of the set of visual features with the at least one feature in the first set of map data.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an ultrawide band (UWB) module 1538, an in-cabin monitoring system (ICMS) 1540, an SPS module 1516 (e.g., GNSS module), one or more sensors 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the UWB module 1538, the ICMS 1540, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the map-aiding positioning component 198 may be configured to perform map-aiding positioning based on a first set of map data. The map-aiding positioning component 198 may also be configured to verify whether an integrity of the first set of map data meets an accuracy threshold. The map-aiding positioning component 198 may also be configured to discard the first set of map data if the verification of the integrity of the first set of map data does not meet the accuracy threshold. The map-aiding positioning component 198 may be within the cellular baseband processor(s) 1524, the application processor(s) 1506, or both the cellular baseband processor(s) 1524 and the application processor(s) 1506. The map-aiding positioning component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for performing a map-aiding positioning based on a first set of map data. The apparatus 1504 may further include means for verifying whether an integrity of the first set of map data meets an accuracy threshold. The apparatus 1504 may further include means for discarding the first set of map data if the verification of the integrity of the first set of map data does not meet the accuracy threshold.

In one configuration, apparatus 1504 may further include means for receiving an indication to perform the map-aiding positioning, where the means for performing the map-aiding positioning may include configuring the apparatus 1504 to perform the map-aiding positioning further based on the indication to perform the map-aiding positioning.

In another configuration, the apparatus 1504 may further include means for downloading the first set of map data prior to the performance of the map-aiding positioning, and the means for performing the map-aiding positioning based on the first set of map data may include configuring the apparatus 1504 to perform the map-aiding positioning based on the downloaded first set of map data. In some implementations, the apparatus 1504 may further include means for re-downloading the first set of map data or reporting results of the verification if the verification of the integrity of the first set of map data does not meet the accuracy threshold.

In another configuration, the apparatus 1504 may further include means for outputting an indication of the discarded first set of map data if the verification of the integrity of the first set of map data does not meet the accuracy threshold. In some implementations, the means for outputting the indication of the discarded first set of map data may include configuring the apparatus 1504 to transmit the indication of the discarded first set of map data, or store the indication of the discarded first set of map data.

In another configuration, the means for verifying whether the integrity of the first set of map data meets the accuracy threshold may include configuring the apparatus 1504 to compare the first set of map data with a second set of map data from a different source, and identify the integrity of the first set of map data does not meet the accuracy threshold if the comparison between the first set of map data and the second set of map data shows an indication of inconsistency above a consistency threshold. In some implementations, to compare the first set of map data with the second set of map data, the apparatus 1504 may be configured to compare at least one of a road heading, a road speed limit, a land number, a cross-section geometry, a terrain height, a street name, a landmark validity, a building number, or a real-time traffic condition between the first set of map data and the second set of map data. In some implementations, the second set of map data may be from a local database of the UE, and the apparatus 1504 may further include means for establishing the second set of map data using at least one sensor of the UE.

In another configuration, the means for verifying whether the integrity of the first set of map data meets the accuracy threshold may include configuring the apparatus 1504 to compare the first set of map data with a set of images captured by at least one camera of the UE, and identify the integrity of the first set of map data does not meet the accuracy threshold if the comparison between the first set of map data and the set of images shows an indication of inconsistency above a consistency threshold. In some implementations, the set of images may correspond to a real-time CV or a real-time visual scan captured by the at least one camera of the UE.

In another configuration, the means for verifying whether the integrity of the first set of map data meets the accuracy threshold may include configuring the apparatus 1504 to compare a first UE dynamic derived from the first set of map data with a second UE dynamic derived from real-time GNSS data or from IMU data, and identify the integrity of the first set of map data does not meet the accuracy threshold if the comparison between the first UE dynamic and the second UE dynamic shows an indication of inconsistency above a consistency threshold.

In another configuration, the means for verifying whether the integrity of the first set of map data meets the accuracy threshold may include configuring the apparatus 1504 to compare a first heading of the UE derived from the first set of map data with a second heading of the UE derived from a magnetometer, and identify the integrity of the first set of map data does not meet the accuracy threshold if the comparison between the first heading of the UE and the second heading of the UE shows an indication of inconsistency above a consistency threshold.

In another configuration, the means for verifying whether the integrity of the first set of map data meets the accuracy threshold may include configuring the apparatus 1504 to compare a first set of locations of a set of transmitters derived from the first set of map data with a second set of locations of the set of transmitters derived from at least one communication between the UE and the set of transmitters, and identify the integrity of the first set of map data does not meet the accuracy threshold if the comparison between the first set of locations and the second set of locations shows an indication of inconsistency above a consistency threshold. In some implementations, the set of transmitters includes: a set of Wi-Fi transmitters, a set of TRPs, a set of cell towers, or a combination thereof.

In another configuration, the means for verifying whether the integrity of the first set of map data meets the accuracy threshold may include configuring the apparatus 1504 to compare a first set of locations of a set of objects derived from the first set of map data with a second set of locations of the set of objects derived from at least one radio detection and ranging (radar) sensor, and identify the integrity of the first set of map data does not meet the accuracy threshold if the comparison between the first set of locations and the second set of locations shows an indication of inconsistency above a consistency threshold. In some implementations, the at least one radar sensor includes: at least one RF radar sensor, at least one Lidar sensor, at least one ultra-sound radar sensor, at least one UWB radar sensor, or a combination thereof.

In another configuration, the apparatus 1504 may further include means for prioritizing a first subset of map data and a second subset of map data in the first set of map data for downloading or buffering based on a modality of the UE, and means for downloading or means for buffering the first subset of map data and the second subset of map data based on the prioritization. In some implementations, the first subset of map data may correspond to a defined proximity area of the UE and the second subset of map data may correspond to areas outside the defined proximity area, and the first subset of map data may be prioritized over the second subset of map data. In some implementations, the second subset of map data may be down-sampled.

In another configuration, the apparatus 1504 may further include means for associating a tracking device or an object with a set of visual features surrounding the tracking device or the object, means for comparing the set of visual features with at least one feature in the first set of map data, and means for locating the tracking device or the object based on the comparison of the set of visual features with the at least one feature in the first set of map data.

The means may be the map-aiding positioning component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a user equipment (UE), comprising: performing a map-aiding positioning based on a first set of map data; verifying whether an integrity of the first set of map data meets an accuracy threshold; and discarding the first set of map data if the verification of the integrity of the first set of map data does not meet the accuracy threshold.

Aspect 2 is the method of aspect 1, further comprising: outputting an indication of the discarded first set of map data if the verification of the integrity of the first set of map data does not meet the accuracy threshold.

Aspect 3 is the method of aspect 1 or aspect 2, wherein outputting the indication of the discarded first set of map data comprises: transmitting the indication of the discarded first set of map data; or storing the indication of the discarded first set of map data.

Aspect 4 is the method of any of aspects 1 to 3, further comprising: downloading the first set of map data prior to the performance of the map-aiding positioning, and wherein performing the map-aiding positioning based on the first set of map data comprises performing the map-aiding positioning based on the downloaded first set of map data.

Aspect 5 is the method of any of aspects 1 to 4, further comprising: re-downloading the first set of map data or reporting results of the verification if the verification of the integrity of the first set of map data does not meet the accuracy threshold.

Aspect 6 is the method of any of aspects 1 to 5, further comprising: receiving an indication to perform the map-aiding positioning, wherein performing the map-aiding positioning comprises performing the map-aiding positioning further based on the indication to perform the map-aiding positioning.

Aspect 7 is the method of any of aspects 1 to 6, wherein the first set of map data includes: a set of two-dimensional (2D) map data, a set of three-dimensional (3D) map data, a set of high-definition (HD) map data, a set of street views, or a combination thereof.

Aspect 8 is the method of any of aspects 1 to 7, wherein verifying whether the integrity of the first set of map data meets the accuracy threshold comprises: comparing the first set of map data with a second set of map data from a different source; and identifying the integrity of the first set of map data does not meet the accuracy threshold if the comparison between the first set of map data and the second set of map data shows an indication of inconsistency above a consistency threshold.

Aspect 9 is the method of any of aspects 1 to 8, wherein comparing the first set of map data with the second set of map data comprises: comparing at least one of a road heading, a road speed limit, a land number, a cross-section geometry, a terrain height, a street name, a landmark validity, a building number, or a real-time traffic condition between the first set of map data and the second set of map data.

Aspect 10 is the method of any of aspects 1 to 9, wherein the second set of map data is from a local database of the UE, the method further comprising: establishing the second set of map data using at least one sensor of the UE.

Aspect 11 is the method of any of aspects 1 to 10, wherein verifying whether the integrity of the first set of map data meets the accuracy threshold comprises: comparing the first set of map data with a set of images captured by at least one camera of the UE; and identifying the integrity of the first set of map data does not meet the accuracy threshold if the comparison between the first set of map data and the set of images shows an indication of inconsistency above a consistency threshold.

Aspect 12 is the method of any of aspects 1 to 11, wherein the set of images corresponds to a real-time computer vision (CV) or a real-time visual scan captured by the at least one camera of the UE.

Aspect 13 is the method of any of aspects 1 to 12, wherein verifying whether the integrity of the first set of map data meets the accuracy threshold comprises: comparing a first UE dynamic derived from the first set of map data with a second UE dynamic derived from real-time global navigation satellite system (GNSS) data or from inertial measurement unit (IMU) data; and identifying the integrity of the first set of map data does not meet the accuracy threshold if the comparison between the first UE dynamic and the second UE dynamic shows an indication of inconsistency above a consistency threshold.

Aspect 14 is the method of any of aspects 1 to 13, wherein verifying whether the integrity of the first set of map data meets the accuracy threshold comprises: comparing a first heading of the UE derived from the first set of map data with a second heading of the UE derived from a magnetometer; and identifying the integrity of the first set of map data does not meet the accuracy threshold if the comparison between the first heading of the UE and the second heading of the UE shows an indication of inconsistency above a consistency threshold.

Aspect 15 is the method of any of aspects 1 to 14, wherein verifying whether the integrity of the first set of map data meets the accuracy threshold comprises: comparing a first set of locations of a set of transmitters derived from the first set of map data with a second set of locations of the set of transmitters derived from at least one communication between the UE and the set of transmitters; and identifying the integrity of the first set of map data does not meet the accuracy threshold if the comparison between the first set of locations and the second set of locations shows an indication of inconsistency above a consistency threshold.

Aspect 16 is the method of any of aspects 1 to 15, wherein the set of transmitters includes: a set of Wi-Fi transmitters, a set of transmission reception points (TRPs), a set of cell towers, or a combination thereof.

Aspect 17 is the method of any of aspects 1 to 16, wherein verifying whether the integrity of the first set of map data meets the accuracy threshold comprises: comparing a first set of locations of a set of objects derived from the first set of map data with a second set of locations of the set of objects derived from at least one radio detection and ranging (radar) sensor; and identifying the integrity of the first set of map data does not meet the accuracy threshold if the comparison between the first set of locations and the second set of locations shows an indication of inconsistency above a consistency threshold.

Aspect 18 is the method of any of aspects 1 to 17, wherein the at least one radar sensor includes: at least one radio frequency (RF) radar sensor, at least one light detection and ranging (Lidar) sensor, at least one ultra-sound radar sensor, at least one ultra-wideband (UWB) radar sensor, or a combination thereof.

Aspect 19 is the method of any of aspects 1 to 18, further comprising: prioritizing a first subset of map data and a second subset of map data in the first set of map data for downloading or buffering based on a modality of the UE; and downloading or buffering the first subset of map data and the second subset of map data based on the prioritization.

Aspect 20 is the method of any of aspects 1 to 19, wherein the first subset of map data corresponds to a defined proximity area of the UE and the second subset of map data corresponds to areas outside the defined proximity area, and wherein the first subset of map data is prioritized over the second subset of map data.

Aspect 21 is the method of any of aspects 1 to 20, wherein the second subset of map data is down-sampled.

Aspect 22 is the method of any of aspects 1 to 21, further comprising: associating a tracking device or an object with a set of visual features surrounding the tracking device or the object; comparing the set of visual features with at least one feature in the first set of map data; and locating the tracking device or the object based on the comparison of the set of visual features with the at least one feature in the first set of map data.

Aspect 23 is an apparatus for wireless communication at a user equipment (UE), including: at least one memory; and at least one processor coupled to the at least one memory and, based at least in part on information stored in the at least one memory, the at least one processor, individually or in any combination, is configured to implement any of aspects 1 to 22.

Aspect 24 is the apparatus of aspect 23, further including at least one of a transceiver or an antenna coupled to the at least one processor.

Aspect 25 is an apparatus for wireless communication including means for implementing any of aspects 1 to 22.

Aspect 26 is a computer-readable medium (e.g., a non-transitory computer-readable medium) storing computer executable code, where the code when executed by a processor causes the processor to implement any of aspects 1 to 22.

What is claimed is:

1. An apparatus for wireless communication at a user equipment (UE), comprising:
at least one memory;
at least one transceiver; and
at least one processor coupled to the at least one memory, the at least one processor, individually or in any combination, is configured to:
perform map-aiding positioning based on a first set of map data;
verify whether an integrity of the first set of map data meets an accuracy threshold; and
discard the first set of map data if the verification of the integrity of the first set of map data does not meet the accuracy threshold.

2. The apparatus of claim 1, wherein the at least one processor, individually or in any combination, is further configured to:
output an indication of the discarded first set of map data if the verification of the integrity of the first set of map data does not meet the accuracy threshold.

3. The apparatus of claim 2, wherein to output the indication of the discarded first set of map data, the at least one processor, individually or in any combination, is configured to:
transmit, via the at least one transceiver, the indication of the discarded first set of map data; or
store the indication of the discarded first set of map data.

4. The apparatus of claim 1, wherein the at least one processor, individually or in any combination, is further configured to:
download, via the at least one transceiver, the first set of map data prior to the performance of the map-aiding positioning, and wherein to perform the map-aiding positioning based on the first set of map data, the at least one processor, individually or in any combination, is configured to perform the map-aiding positioning based on the downloaded first set of map data.

5. The apparatus of claim 4, wherein the at least one processor, individually or in any combination, is further configured to:
re-download, via the at least one transceiver, the first set of map data or reporting results of the verification if the verification of the integrity of the first set of map data does not meet the accuracy threshold.

6. The apparatus of claim 1, wherein the at least one processor, individually or in any combination, is further configured to:
receive, via at least one of the transceiver, an indication to perform the map-aiding positioning, wherein to perform the map-aiding positioning, the at least one processor, individually or in any combination, is configured to perform the map-aiding positioning further based on the indication to perform the map-aiding positioning.

7. The apparatus of claim 1, wherein the first set of map data includes:
a set of two-dimensional (2D) map data,
a set of three-dimensional (3D) map data,
a set of high-definition (HD) map data,
a set of street views, or
a combination thereof.

8. The apparatus of claim 1, wherein to verify whether the integrity of the first set of map data meets the accuracy threshold, the at least one processor, individually or in any combination, is configured to:
compare the first set of map data with a second set of map data from a different source; and
identify the integrity of the first set of map data does not meet the accuracy threshold if the comparison between the first set of map data and the second set of map data shows an indication of inconsistency above a consistency threshold.

9. The apparatus of claim 8, wherein to compare the first set of map data with the second set of map data, the at least one processor, individually or in any combination, is configured to:
compare at least one of a road heading, a road speed limit, a land number, a cross-section geometry, a terrain height, a street name, a landmark validity, a building number, or a real-time traffic condition between the first set of map data and the second set of map data.

10. The apparatus of claim 8, wherein the second set of map data is from a local database of the UE, wherein the at least one processor, individually or in any combination, is further configured to:
establish the second set of map data using at least one sensor of the UE.

11. The apparatus of claim 1, wherein to verify whether the integrity of the first set of map data meets the accuracy threshold, the at least one processor, individually or in any combination, is configured to:
compare the first set of map data with a set of images captured by at least one camera of the UE; and
identify the integrity of the first set of map data does not meet the accuracy threshold if the comparison between the first set of map data and the set of images shows an indication of inconsistency above a consistency threshold.

12. The apparatus of claim 11, wherein the set of images corresponds to a real-time computer vision (CV) or a real-time visual scan captured by the at least one camera of the UE.

13. The apparatus of claim 1, wherein to verify whether the integrity of the first set of map data meets the accuracy threshold, the at least one processor, individually or in any combination, is configured to:
compare a first UE dynamic derived from the first set of map data with a second UE dynamic derived from real-time global navigation satellite system (GNSS) data or from inertial measurement unit (IMU) data; and
identify the integrity of the first set of map data does not meet the accuracy threshold if the comparison between the first UE dynamic and the second UE dynamic shows an indication of inconsistency above a consistency threshold.

14. The apparatus of claim 1, wherein to verify whether the integrity of the first set of map data meets the accuracy threshold, the at least one processor, individually or in any combination, is configured to:
compare a first heading of the UE derived from the first set of map data with a second heading of the UE derived from a magnetometer; and
identify the integrity of the first set of map data does not meet the accuracy threshold if the comparison between the first heading of the UE and the second heading of the UE shows an indication of inconsistency above a consistency threshold.

15. The apparatus of claim 1, wherein to verify whether the integrity of the first set of map data meets the accuracy threshold, the at least one processor, individually or in any combination, is configured to:
compare a first set of locations of a set of transmitters derived from the first set of map data with a second set of locations of the set of transmitters derived from at least one communication between the UE and the set of transmitters; and
identify the integrity of the first set of map data does not meet the accuracy threshold if the comparison between the first set of locations and the second set of locations shows an indication of inconsistency above a consistency threshold.

16. The apparatus of claim 15, wherein the set of transmitters includes:
a set of Wi-Fi transmitters,
a set of transmission reception points (TRPs),
a set of cell towers, or
a combination thereof.

17. The apparatus of claim 1, wherein to verify whether the integrity of the first set of map data meets the accuracy threshold, the at least one processor, individually or in any combination, is configured to:
compare a first set of locations of a set of objects derived from the first set of map data with a second set of locations of the set of objects derived from at least one radio detection and ranging (radar) sensor; and
identify the integrity of the first set of map data does not meet the accuracy threshold if the comparison between the first set of locations and the second set of locations shows an indication of inconsistency above a consistency threshold.

18. The apparatus of claim 17, wherein the at least one radar sensor includes:
at least one radio frequency (RF) radar sensor,
at least one light detection and ranging (Lidar) sensor,
at least one ultra-sound radar sensor,
at least one ultra-wideband (UWB) radar sensor, or
a combination thereof.

19. The apparatus of claim 1, wherein the at least one processor, individually or in any combination, is further configured to:
prioritize a first subset of map data and a second subset of map data in the first set of map data for downloading or buffering based on a modality of the UE; and
download or buffer the first subset of map data and the second subset of map data based on the prioritization.

20. The apparatus of claim 19, wherein the first subset of map data corresponds to a defined proximity area of the UE and the second subset of map data corresponds to areas outside the defined proximity area, and wherein the first subset of map data is prioritized over the second subset of map data.

21. The apparatus of claim 20, wherein the second subset of map data is down-sampled.

22. The apparatus of claim 1, wherein the at least one processor, individually or in any combination, is further configured to:
associate a tracking device or an object with a set of visual features surrounding the tracking device or the object;
compare the set of visual features with at least one feature in the first set of map data; and
locate the tracking device or the object based on the comparison of the set of visual features with the at least one feature in the first set of map data.

23. A method of wireless communication at a user equipment (UE), comprising:
performing a map-aiding positioning based on a first set of map data;
verifying whether an integrity of the first set of map data meets an accuracy threshold; and
discarding the first set of map data if the verification of the integrity of the first set of map data does not meet the accuracy threshold.

24. The method of claim 23, wherein verifying whether the integrity of the first set of map data meets the accuracy threshold comprises:
comparing the first set of map data with a second set of map data from a different source; and
identifying the integrity of the first set of map data does not meet the accuracy threshold if the comparison between the first set of map data and the second set of map data shows an indication of inconsistency above a consistency threshold.

25. The method of claim 23, wherein verifying whether the integrity of the first set of map data meets the accuracy threshold comprises:
comparing the first set of map data with a set of images captured by at least one camera of the UE; and
identifying the integrity of the first set of map data does not meet the accuracy threshold if the comparison between the first set of map data and the set of images shows an indication of inconsistency above a consistency threshold.

26. The method of claim 23, wherein verifying whether the integrity of the first set of map data meets the accuracy threshold comprises:
comparing a first UE dynamic derived from the first set of map data with a second UE dynamic derived from real-time global navigation satellite system (GNSS) data or from inertial measurement unit (IMU) data; and
identifying the integrity of the first set of map data does not meet the accuracy threshold if the comparison between the first UE dynamic and the second UE dynamic shows an indication of inconsistency above a consistency threshold.

27. The method of claim 23, wherein verifying whether the integrity of the first set of map data meets the accuracy threshold comprises:
comparing a first heading of the UE derived from the first set of map data with a second heading of the UE derived from a magnetometer; and
identifying the integrity of the first set of map data does not meet the accuracy threshold if the comparison between the first heading of the UE and the second heading of the UE shows an indication of inconsistency above a consistency threshold.

28. The method of claim 23, wherein verifying whether the integrity of the first set of map data meets the accuracy threshold comprises:
comparing a first set of locations of a set of transmitters derived from the first set of map data with a second set of locations of the set of transmitters derived from at least one communication between the UE and the set of transmitters; and
identifying the integrity of the first set of map data does not meet the accuracy threshold if the comparison between the first set of locations and the second set of locations shows an indication of inconsistency above a consistency threshold.

29. An apparatus for wireless communication at a user equipment (UE), comprising:
means for performing a map-aiding positioning based on a first set of map data;
means for verifying whether an integrity of the first set of map data meets an accuracy threshold; and
means for discarding the first set of map data if the verification of the integrity of the first set of map data does not meet the accuracy threshold.

30. A computer-readable medium storing computer executable code at a user equipment (UE), the code when executed by at least one processor causes the at least one processor to:
perform map-aiding positioning based on a first set of map data;
verify whether an integrity of the first set of map data meets an accuracy threshold; and
discard the first set of map data if the verification of the integrity of the first set of map data does not meet the accuracy threshold.
